(19) United States
(12) Patent Application Publication
(10) Pub. No.: US 2007/0139056 A1
(43) Pub. Date: Jun. 21, 2007

(54) PARTIAL DISCHARGE DETECTION APPARATUS AND DETECTION METHOD OF ELECTRICAL ROTATING MACHINE

(76) Inventors: Hiroshi KANEIWA, Yokohama-shi (JP); Masahiro Sakai, Yokohama-shi (JP); Yoshiyuki Inoue, Yokohama-shi (JP); Shinobu Sekito, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/676,932

(22) Filed: Feb. 20, 2007

Related U.S. Application Data
(63) Continuation of application No. PCT/JP05/15159, filed on Aug. 19, 2005.

(30) Foreign Application Priority Data
Aug. 20, 2004 (JP) 2004-241217
Aug. 25, 2004 (JP) 2004-245465

(51) Int. Cl. H01H 9/50

(52) U.S. Cl. 324/536

(57) ABSTRACT

A partial discharge detection apparatus of an electrical rotating machine includes a metal frame connected to a stator frame of the electrical rotating machine, a power line connected to one of a stator winding corresponding to one phase of three phases in the metal frame and a neutral point lead line connected to a neutral point of three-phase stator windings and arranged in the metal frame to propagate a partial discharge signal generated by degradation of the stator winding, a sensor including a rod antenna which is installed around the power line or neutral point lead line in the metal frame to electrostatically and magnetically induce the partial discharge signal propagated to the power line or neutral point lead line, and a detector which receives, via a signal lead line, a signal generated in the sensor and detects partial discharge by signal processing.

### CROSS-REFERENCE TO RELATED APPLICATIONS

This is a Continuation Application of PCT Application No. PCT/JP2005/015159, filed Aug. 19, 2005, which was published under PCT Article 21(2) in Japanese.

This application is based upon and claims the benefit of priority from prior Japanese Patent Applications No. 2004-241217, filed Aug. 20, 2004; and No. 2004-245465, filed Aug. 25, 2004, the entire contents of both of which are incorporated herein by reference.

### BACKGROUND OF THE INVENTION

1. Field of the Invention

The present invention relates to a partial discharge detection apparatus and detection method of an electrical rotating machine.

2. Description of the Related Art

When a high-voltage electrical rotating machine is continuously operated for a long time, degradation of electrical insulation inside the machine progresses due to electrical, thermal, mechanical, and environmental stress. This may finally lead to dielectric breakdown and malfunction of the machine.

From the viewpoint of reliability and operation management, a high-voltage electrical rotating machine requires to monitor and diagnose the internal insulation degradation. Especially, the stator winding of an electrical rotating machine receives large electrical, thermal, and mechanical stress, and it is therefore important to monitor and diagnose the insulation degradation of the stator winding.

To detect degradation of insulation in a stator winding, a method of detecting a pulse-like signal caused by a partial discharge generated in the degraded insulation of the stator winding is employed. However, it is difficult to directly detect the partial discharge that has occurred in the coil inside an electrical rotating machine.

Conventionally, as disclosed in, e.g., Jpn. Pat. Appln. KOKAI Publication No. 4-299048, a detection sensor is installed in a stator winding or attached to an end space inside an electrical rotating machine to detect an electromagnetic wave that propagates in the electrical rotating machine or an electrical pulse signal that flows through a coil, coil connection line, and power line upon occurrence of partial discharge.

In this method, since the distance between a place at which the partial discharge occurs and the sensor is very short, the detection sensitivity is high, and detected noise may be small. However, installation of the sensor must be done after the coil is removed, thereby being time-consuming. In addition, attachment of the sensor is difficult.

The necessity of insulation degradation diagnosis is high especially for an existing electrical rotating machine that is in operation for decades. To do this, a partial discharge detection sensor easy to additionally attach to such an existing electrical rotating machine is necessary.

For example, Jpn. Pat. Appln. KOKAI Publication No. 4-299050 discloses a method of detecting a partial discharge signal by connecting a direct detection sensor such as an electrostatic capacitor or current transformer to a high-voltage charge unit such as a stator winding in an electrical rotating machine or a power line connected to an electrical rotating machine.

This detection method can ensure high detection sensitivity. However, since high electrical stress is applied to the direct detection sensor, the sensor itself is required to have high insulating performance.

### BRIEF SUMMARY OF THE INVENTION

As described above, in the conventional partial discharge detection methods, attachment of the detection senor requires labor and time, and the sensor itself needs to have high insulating performance.

It is an object of the present invention to provide a partial discharge detection method and apparatus which enable easy attachment to a high-voltage unit in a noncontact state and ensure a high detection sensitivity and detection accuracy.

A partial discharge detection apparatus of an electrical rotating machine according to the present invention comprises a metal frame connected to a stator frame of the electrical rotating machine, a power line or neutral point lead line connected to a stator winding in the metal frame and arranged in the metal frame to propagate a partial discharge signal generated by degradation of the stator winding, a sensor including a rod antenna or loop antenna installed around the power line or neutral point lead line in the metal frame to electrostatically and magnetically induce the partial discharge signal propagated to the power line or neutral point lead line, and a detector which receives, via a signal lead line, a signal generated in the sensor and detects partial discharge by signal processing.

A partial discharge detection method of an electrical rotating machine according to the present invention comprises arranging, in a metal frame connected to a stator frame of the electrical rotating machine, a power line connected to a stator winding corresponding to each phase of three phases in the metal frame or a neutral point lead line, installing two sensors of the same phase each including a rod antenna, a loop antenna, or a plurality of rod antennas each having one end electrically connected while spacing the two sensors apart by a predetermined distance at least at two points for each phase of the power lines or the neutral point lead line, and detecting the partial discharge signal generated by degradation of the stator windings by comparing arrival time lags of output signal waveforms obtained through two signal lead lines which have the same length or a known length difference and connect to the two sensors in the same phase.

A partial discharge detection apparatus of an electrical rotating machine according to the present invention comprises an electrical conductive element which is electrostatically coupled to a power line connected to a stator winding of the electrical rotating machine or a neutral point lead line and is in non-contact with the power line or neutral point lead line, an impedance converter which has an input terminal electrically connected to a terminal of the electrical conductive element and has an input impedance higher than an output impedance, and signal processing means for processing a detection signal obtained from an output terminal of the impedance converter to detect a partial discharge pulse signal.

A partial discharge detection method of an electrical rotating machine according to the present invention comprises electrically connecting an output terminal of an electrical conductive element that has an electrostatic coupling of not more than 10 pF with a power line connected to a stator winding of the electrical rotating machine or neutral point lead line and is in non-contact with the power line or neutral point lead line to an input terminal of an impedance converter having an input impedance of not less than 500 Ω and an output impedance of 50 Ω to 75 Ω and detecting a partial discharge signal by processing a detection signal obtained from an output terminal of a transmission circuit which has a characteristic impedance of 50 Ω to 75 Ω and is connected to the output terminal of the impedance converter so as to match the impedances.

### BRIEF DESCRIPTION OF THE SEVERAL VIEWS OF THE DRAWING

FIG. 1A is a view showing a partial discharge detection apparatus of an electrical rotating machine according to the first embodiment of the present invention, which uses a power line connected to a stator winding;

FIG. 1B is a view showing a partial discharge detection apparatus of an electrical rotating machine according to the first embodiment of the present invention, which uses a neutral point lead line connected to the neutral point of stator windings;

FIG. 2 is a view showing a rod antenna serving as a sensor according to the first embodiment and its support structure;

FIG. 3 is a block diagram showing an arrangement example of a detector according to the first embodiment;

FIG. 4 is a chart showing an output voltage waveform so as to explain the function of the detector;

FIG. 5 is a waveform chart showing an example of a partial discharge pulse propagated to a conductor and a waveform detected by the rod antenna in the first embodiment, which are displayed on a waveform observer;

FIG. 6 is a view showing a loop-shaped antenna serving as a sensor according to the first embodiment and its support structure;

FIG. 7A is an axial sectional view showing a partial discharge detection apparatus of an electrical rotating machine according to the second embodiment of the present invention;

FIG. 7B is a radial sectional view of the partial discharge detection apparatus of the second embodiment;

FIG. 8 is a waveform chart showing the relationship between the number of rod antennas and the antenna output voltage in the second embodiment;

FIG. 9 is a view showing an example in which a plurality of rod antennas connected in series on one side are arranged in a line or circular arc as a sensor according to the second embodiment;

FIG. 10A is an axial sectional view showing a partial discharge detection apparatus of an electrical rotating machine according to the third embodiment of the present invention;

FIG. 10B is a radial sectional view of the apparatus according to the third embodiment;

FIG. 11A is an axial sectional view showing a connection arrangement for receiving to a detector a high-frequency current through a resistor connected between an electrode and a metal frame in the third embodiment;

FIG. 11B is a radial sectional view showing the connection arrangement for receiving at the detector a high-frequency current through the resistor;

FIG. 12 is a waveform chart showing examples of a partial discharge pulse propagated to a conductor and a waveform detected through the resistor connected to the electrode in the third embodiment, which are displayed by a waveform observer;

FIG. 13A is an axial sectional view showing a connection arrangement for receiving at the detector a high-frequency current from a current transformer inserted in a conductor that connects the electrode and metal frame in the third embodiment;

FIG. 13B is a radial sectional view showing the connection arrangement for receiving at the detector a high-frequency current from the current transformer;

FIG. 14A is an axial sectional view showing an arrangement in which arc-shaped divided electrodes are disposed concentrically about a power line in the third embodiment;

FIG. 14B is a radial sectional view showing the arrangement in which the arc-shaped divided electrodes are disposed concentrically about the power line;

FIG. 15A is an axial sectional view showing a partial discharge detection apparatus of an electrical rotating machine according to the fourth embodiment of the present invention;

FIG. 15B is a radial sectional view of the fourth embodiment;

FIG. 16A is an axial sectional view showing a connection arrangement for receiving at a detector a high-frequency current from a high-frequency current transformer inserted in a conductor that connects an electrode and a metal frame in the fourth embodiment;

FIG. 16B is a radial sectional view showing the connection arrangement for receiving at the detector a high-frequency current from the high-frequency current transformer;

FIG. 17 is a view showing a partial discharge detection apparatus of an electrical rotating machine according to the fifth embodiment of the present invention;

FIG. 18 is a waveform chart showing pulse waveforms that are obtained by connecting detection leads with the same length to two sensors and observing outputs by using a simultaneous waveform observation device in the fifth embodiment;

FIG. 19 is a waveform chart showing pulse waveforms that are obtained by observing outputs by using a simultaneous waveform observation device upon detecting when the pulses are propagated in a direction to enter the electrical rotating machine from its opposite side;

FIG. 20 is a view showing a partial discharge detection apparatus of an electrical rotating machine according to the sixth embodiment of the present invention;

FIG. 21 is a waveform chart showing waveforms obtained when a signal is propagated in a direction to enter the electrical rotating machine in the sixth embodiment;

FIG. 22 is a waveform chart showing waveforms obtained when a signal is propagated from the electrical rotating machine to the outside;

FIG. 23A is a longitudinal sectional view showing the structure of a microstrip antenna serving as a sensor according to the seventh embodiment of the present invention;

FIG. 23B is a cross-sectional view of the microstrip antenna;

FIG. 24 is an equivalent circuit diagram of the microstrip antenna;

FIG. 25 is a view showing the directivities of currents I₀ and I₁ which are generated in the microstrip antenna by an electromagnetic wave propagated in a space in this embodiment;

FIG. 26 is a view showing a state wherein the microstrip antenna of the seventh embodiment is attached to the inner surface of a metal frame;

FIG. 27 is a waveform chart showing waveforms obtained by detecting partial discharge generated at a stator winding by using the microstrip antenna installed between a high-voltage conductor and a metal frame in the seventh embodiment;

FIG. 28 is a view showing a partial discharge detection apparatus of an electrical rotating machine according to the eighth embodiment of the present invention;

FIG. 29 is an electrical equivalent circuit diagram representing the partial discharge detection apparatus according to the eighth embodiment, which is viewed from a power line or neutral point lead line;

FIG. 30 is a view showing the partial discharge detection apparatus which connects a transmission line having a characteristic impedance directly to an electrical conductive element without using an impedance converter;

FIG. 31 is an electrical equivalent circuit diagram showing a circuit formed by connecting an electrostatic capacitance and an impedance in series in FIG. 30;

FIG. 32 is a waveform chart showing comparison of the frequency characteristic of a detection gain between the arrangement of the eighth embodiment and the arrangement shown in FIG. 30;

FIG. 33 is an electrical equivalent circuit diagram viewed from a signal processor in the eighth embodiment;

FIG. 34A is a waveform chart showing a voltage waveform obtained from a terminal of a transmission line when resistive terminators equivalent to the transmission line are connected to the two terminals of the transmission line;

FIG. 34B is a waveform chart showing a voltage waveform obtained from the terminal of the transmission line when the resistive terminators are removed from the two terminals of the transmission line to open the terminals;

FIG. 35A is a waveform chart showing examples of waveforms when a partial discharge pulse is observed by using the detection method performed by the apparatus shown in FIG. 28;

FIG. 35B is a waveform chart showing examples of waveforms when a partial discharge pulse is observed by using the detection method performed by the apparatus shown in FIG. 30;

FIG. 36 is a view showing a partial discharge detection apparatus of an electrical rotating machine according to the ninth embodiment of the present invention;

FIG. 37 is a view showing the detection functions of two impedance converters according to the ninth embodiment;

FIG. 38 is a view showing the generation frequency band of an inverter noise that is supposed to be a noise factor upon partial discharge detection and of a partial discharge waveform in the electrical rotating machine;

FIG. 39 is a waveform chart showing signal waveforms that appear at a power line and the output terminals of transmission paths of two impedance converters in the ninth embodiment;

FIG. 40 is a view showing a partial discharge detection apparatus of an electrical rotating machine according to the 10th embodiment of the present invention;

FIG. 41 is a view showing the procedure and time required for attaching a partial discharge detection apparatus according to the 10th embodiment;

FIG. 42 is a view showing a partial discharge detection apparatus of an electrical rotating machine according to the 11th embodiment of the present invention;

FIG. 43 is a view showing a partial discharge detection apparatus of an electrical rotating machine according to the 12th embodiment of the present invention;

FIG. 44 is a function explanatory view for discriminating the pulse propagation direction imparted to a signal processor in the 12th embodiment;

FIG. 45A is a waveform chart showing the voltage waveforms of a partial discharge signal from two sensors induced by a partial discharge pulse that flows from the stator winding of the electrical rotating machine to the outside in the 12th embodiment;

FIG. 45B is a waveform chart showing the voltage waveforms of a pulse from two sensors induced by a noise pulse that flows from the outside to the stator winding of the electrical rotating machine;

FIG. 46 is a view showing a partial discharge detection apparatus of an electrical rotating machine according to the 13th embodiment of the present invention;

FIG. 47 is an electrical equivalent circuit diagram showing the partial discharge detection apparatus according to the 13th embodiment, which is viewed from a power line or neutral point lead line; and

FIG. 48 is a chart showing comparison of the frequency characteristic of a detection gain between the 13th embodiment of the present invention and the arrangement shown in FIG. 30.

### DETAILED DESCRIPTION OF THE INVENTION

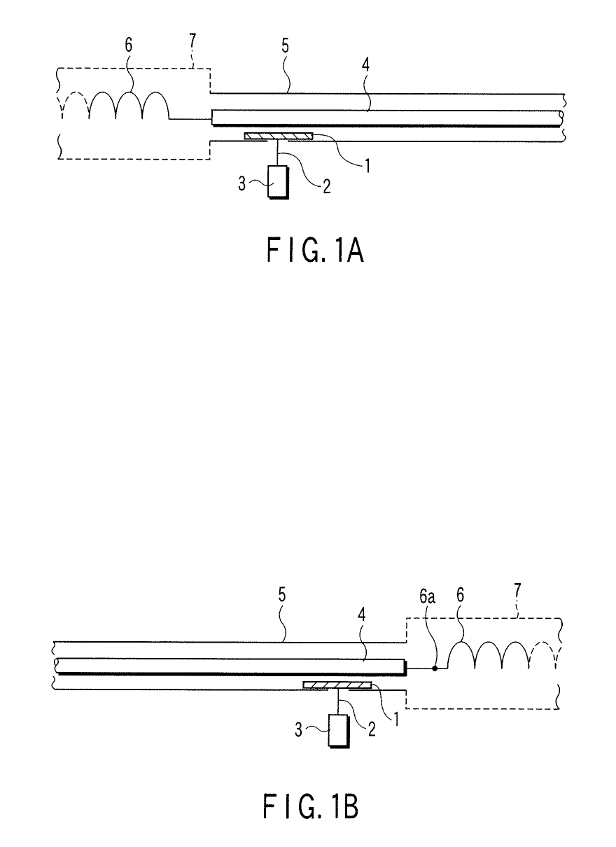

FIG. 1A is a view showing a partial discharge detection apparatus of an electrical rotating machine according to the first embodiment of the present invention, which uses a power line connected to stator windings. FIG. 1B is a view showing a partial discharge detection apparatus of an electrical rotating machine, which uses a neutral point lead line connected to the neutral point of stator windings.

Referring to FIGS. 1A and 1B, a stator winding 6 corresponding to one phase of the three phases (FIGS. 1A and 1B show one phase) of the electrical rotating machine is stored in a slot formed in a stator core (not shown) attached to the inner surface of a stator frame 7.

A cylindrical metal frame 5 is attached to the stator frame 7. In FIG. 1A, an insulating support (not shown) supports a power line 4 connected to the stator winding 6. The power line 4 is arranged on the central axis in the metal frame 5. In FIG. 1B, an insulating support (not shown) supports a neutral point lead line 4 connected to a neutral point 6a of the three-phase stator winding. The neutral point lead line 4 is arranged on the central axis in the metal frame 5. A rod antenna 1 made of an electrical conductive material and serving as a sensor is installed in a non-contact state with respect to the power line or neutral point lead line 4.

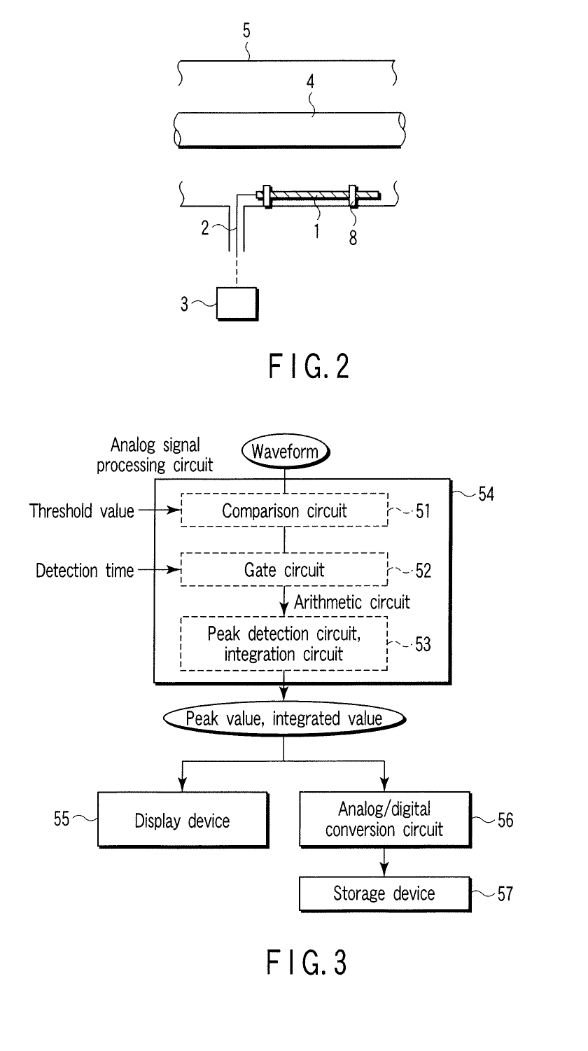

In this case, the rod antenna 1 is arranged parallel to the power line or neutral point lead line 4 and fixed to antenna support insulating members 8 attached to two appropriate points of the metal frame 5, as shown in FIG. 2.

A signal lead line 2 is connected to one end of the rod antenna 1. A partial discharge pulse input through the signal lead line 2 is received by a detector 3 through a resistor or high-frequency current transformer (not shown). A pre-amplifier for signal amplification amplifies the partial discharge pulse input to the detector 3, as needed.

As shown in FIG. 3, the detector 3 comprises an analog signal processing circuit 54 having a comparison circuit 51, gate circuit 52, and arithmetic circuit 53 including an integration circuit and a peak detection circuit, a display device 55 that displays a peak value output from the analog signal processing circuit 54, an analog-to-digital conversion circuit 56 which converts the integrated value output from the analog signal processing circuit 54 into digital data, and a storage device 57 which stores the output from the analog-to-digital conversion circuit 56.

In the partial discharge pulse detection apparatus with the above arrangement, when partial discharge occurs due to insulation degradation of the stator winding 6, the partial discharge signal is propagated to the power line or neutral point lead line 4.

The partial discharge signal is electrostatically or electromagnetically induced from the power line or neutral point lead line 4 to the rod antenna 1 and input from the signal lead line 2 to the detector 3 through a resistor or high-frequency current transformer.

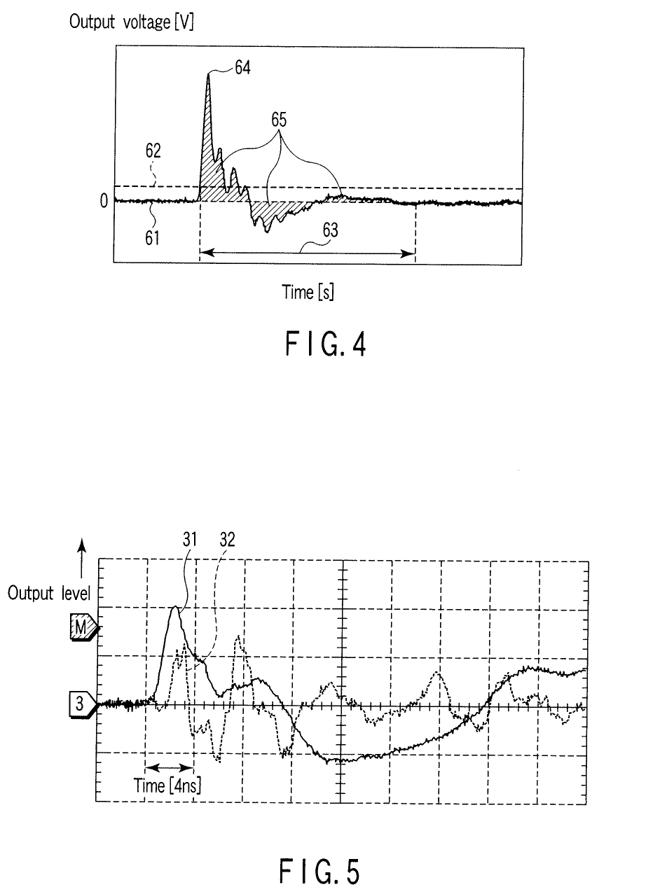

In the detector 3, the comparison circuit 51 compares a predetermined threshold value 62 with a signal waveform value 61, as shown in FIG. 4. The gate circuit 52 neglects a signal equal to or less than the threshold value. The gate circuit 52 receives a signal more than the threshold value for a predetermined period of time 63. The peak detection circuit 53 detects, e.g., a peak value 64 that appears for the first time within that time or a magnitude (integrated value) 65 of partial discharge. The detected value is displayed on the display device 55 of a recorder or a waveform observation device such as an oscilloscope. The analog-to-digital conversion circuit 56 simultaneously converts the peak value into a digital value and stores it in the storage device 57.

FIG. 5 shows examples of waveforms displayed on the waveform observation device, which are obtained by causing the detector 3 and rod antenna 1 to detect a partial discharge pulse propagated to the power line or neutral point lead line 4. As shown in FIG. 5, a pulse signal 31 propagated to the power line or neutral point lead line 4 induces, in the antenna, a pulse waveform 32 having a first wave of the same polarity as the first wave of the propagation pulse in the conductive line.

It is possible to know that partial discharge pulse occurs in the stator winding by observing the pulse waveform of the same polarity as the first wave, which is displayed on the waveform observation device.

The rod antenna 1 serving as a sensor is installed in the metal frame 5 in a non-contact state in correspondence with the power line or neutral point lead line 4 connected to the stator winding 6. The detector 3 can receive and detect a partial discharge signal which is generated due to degradation of the stator winding and electrostatically or electromagnetically induced from the power line or neutral point lead line 4 to the rod antenna 1. It is unnecessary to alter the interior of the electrical rotating machine. It is possible to relatively easily attach a non-contact sensor to a high-voltage unit by only altering the metal frame around the power line or neutral point lead line 4 of the electrical rotating machine.

In the above embodiment, if the power line or neutral point lead line 4 arranged in the metal frame 5 is a power line connected to the stator winding 6, a high voltage is applied near the antenna. It is therefore necessary to moderate the concentration of a electric field by covering the antenna with an insulating material such as epoxy or processing the ends of the antenna.

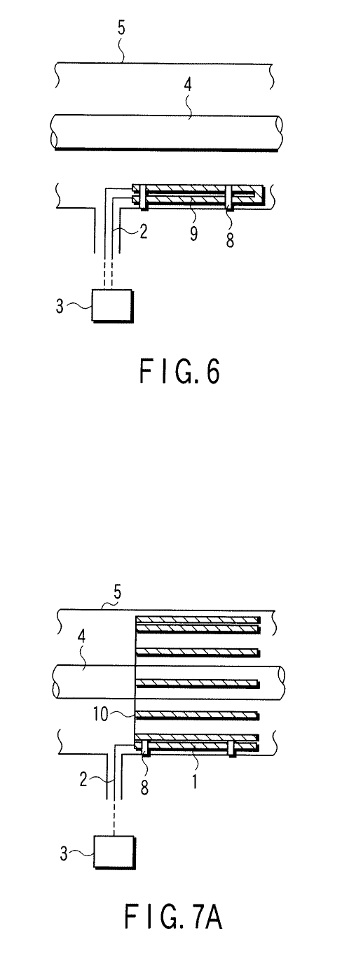

In the above embodiment, the rod antenna 1 serves as a sensor. A loop antenna 9 shown in FIG. 6 can also detect a partial discharge signal which is electrostatically or electromagnetically induced from the power line or neutral point lead line 4.

In the above embodiment, the rod antenna 1 or loop antenna 9 is installed parallel to the power line or neutral point lead line 4. The antenna may be arranged perpendicular to the power line or neutral point lead line 4.

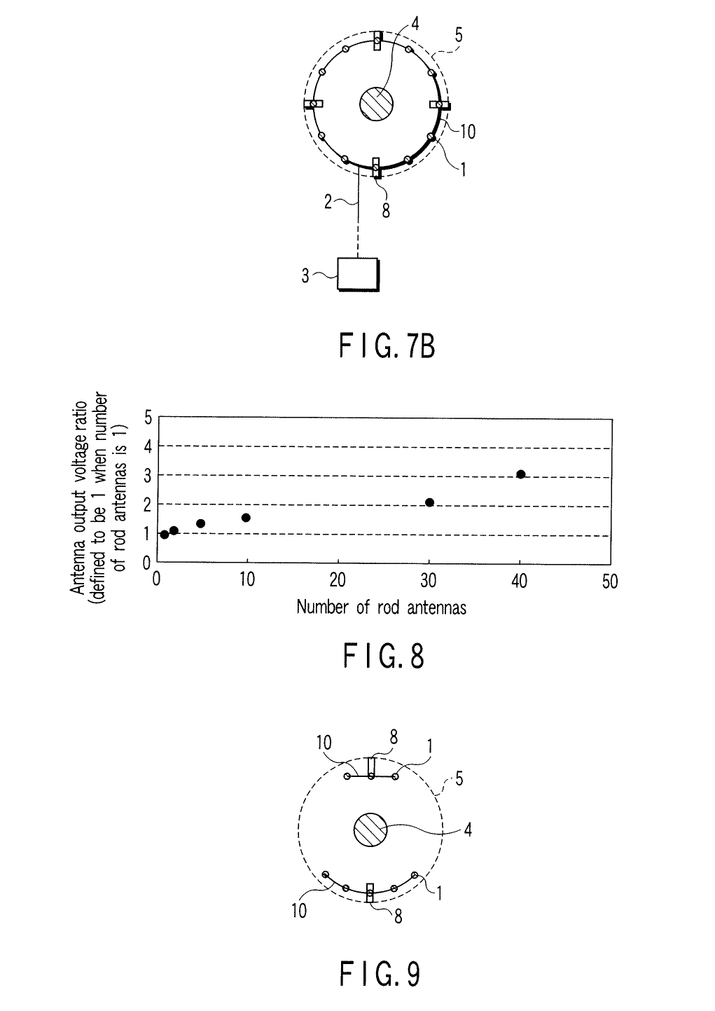

FIG. 7A is an axial sectional view showing a partial discharge detection apparatus of an electrical rotating machine according to the second embodiment of the present invention. FIG. 7B is a radial sectional view. The same reference numbers as in FIGS. 1A, 1B, and 2 denote the same parts in FIGS. 7A and 7B.

In the second embodiment, as shown in FIGS. 7A and 7B, a plurality of rod antennas 1 serving as a sensor are arranged on the inner surface of a metal frame 5 at equal angular intervals about a power line or neutral point lead line 4. Antenna support insulating members 8 fixed to the metal frame 5 support the rod antennas 1. A connection conductor 10 commonly connects one end of each rod antenna 1. The connection conductor 10 is connected to a detector 3 through a signal lead line 2.

FIG. 8 shows the relationship between the number of rod antennas and the detection sensitivity=(the first wave peak value of the detection waveform of the sensor)/(the first wave peak value of the waveform propagated through the power line or neutral point lead line).

The detection sensitivity is defined to be 1 when the number of rod antennas is 1.

As is apparent from the chart shown in FIG. 8, the larger the number of rod antennas is, the higher the sensor output is. The detection sensitivity of the sensor is higher in the arrangement including the plurality of rod antennas than in an arrangement with one rod antenna.

With this arrangement, it is unnecessary to alter the interior of the electrical rotating machine, as in the first embodiment. It is possible to relatively easily attach a non-contact sensor to a high-voltage unit by only altering the metal frame around the power line or neutral point lead line of the electrical rotating machine. Additionally, the detection sensitivity can be increased.

In the second embodiment, the plurality of rod antennas 1 are arranged in a circle. Instead, as shown in FIG. 9, the plurality of rod antennas 1 are arranged concentrically (lower half portion in FIG. 9) or linearly (upper half portion in FIG. 9) with respect to the power line or neutral point lead line 4. Alternatively, as shown in FIG. 9, the rod antennas at the upper half portion are arranged in a line, and those at the lower half portion are arranged in a circular arc and vice versa. Even these arrangements can produce the same function and effect as described above.

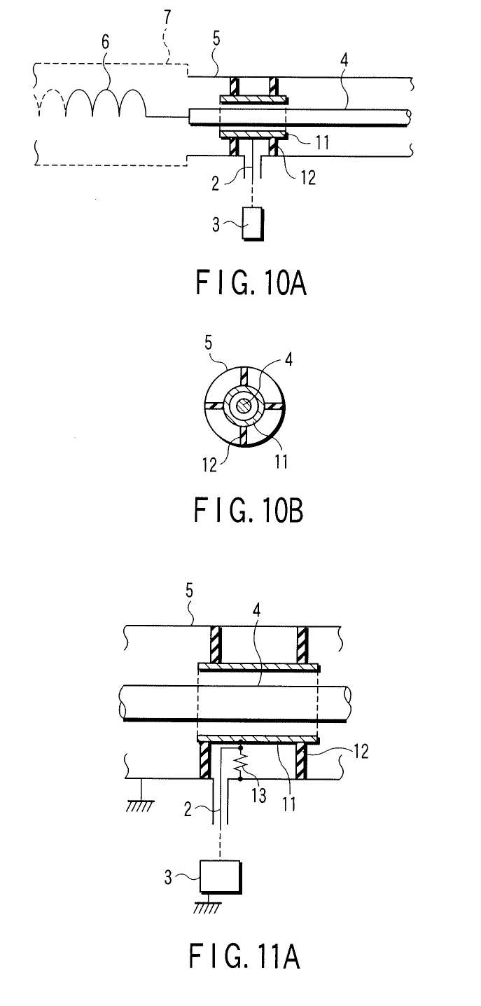

FIG. 10A is an axial sectional view showing a partial discharge detection apparatus of an electrical rotating machine according to the third embodiment of the present invention. FIG. 10B is a radial sectional view thereof. The same reference numbers as in FIGS. 1A and 1B denote the same parts in FIGS. 10A and 10B.

Referring to FIGS. 10A and 10B, a stator winding 6 corresponding to one phase of the three phases (FIGS. 10A and 10B show one phase) of the electrical rotating machine is stored in a slot formed in a stator core (not shown) attached to the inner surface of a stator frame 7.

A cylindrical metal frame 5 is attached to the stator frame 7. An insulating support (not shown) supports a power line or neutral point lead line 4 connected to the stator winding 6. The power line or neutral point lead line 4 is arranged on the central axis in the metal frame 5. A cylindrical electrode 11 electrostatically coupled to the power line or neutral point lead line 4 is arranged concentrically about it. In this case, the electrode 11 is fixed to electrode support insulating members 12 attached to appropriate points of the inner surface of the metal frame 5.

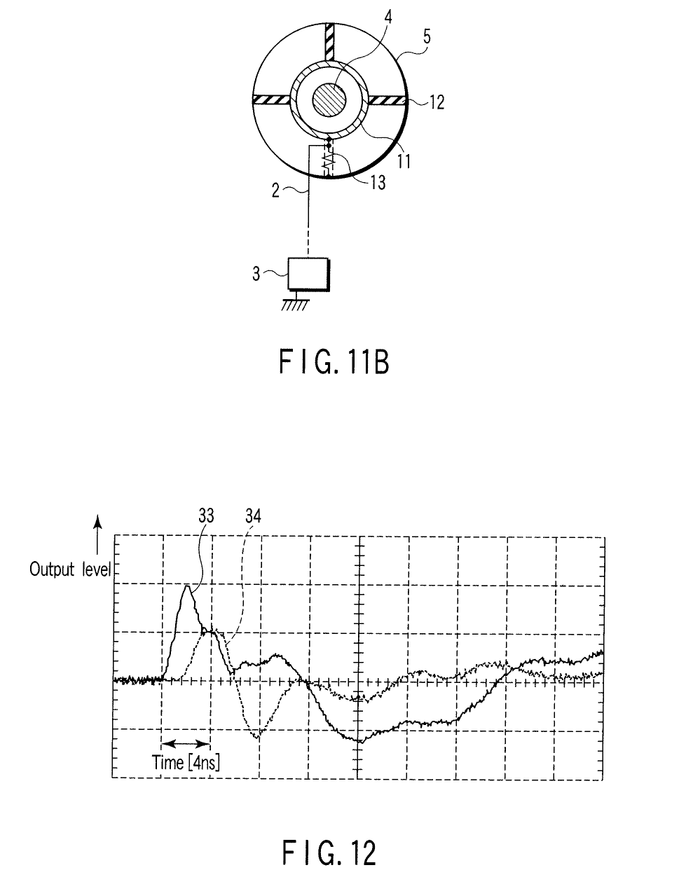

A resistor 13 is connected between the electrode 11 and the metal frame 5, as shown in FIGS. 11A and 11B. A signal lead line 2 is connected to the electrode-side terminal of the resistor 13. A high-frequency current generated based on a partial discharge pulse flowing through the signal lead line 2 is received by a detector 3 through a resistor or current transformer (not shown). A pre-amplifier for signal amplification amplifies the partial discharge pulse input to the detector 3, as needed.

The arrangement of the detector 3 is the same as that shown in FIG. 3 described in the first embodiment, and a description thereof will be omitted.

In the partial discharge pulse detection apparatus with the above arrangement, when partial discharge occurs due to insulation degradation of the stator winding 6, the partial discharge signal is propagated to the power line or neutral point lead line 4.

When the partial discharge signal is propagated to the power line or neutral point lead line 4, a partial discharge signal of a high-frequency current more than several kHz flows through the resistor 13 connected between the metal frame 5 and the electrode 11 electrostatically coupled to the power line or neutral point lead line 4. The high-frequency current is input from the signal lead line 2 to the detector 3 through the resistor or current transformer (not shown).

The detector 3 can detect a signal in an optimum high-frequency band by the same signal processing as described in the first embodiment.

FIG. 12 shows a partial discharge pulse 33 propagated to the power line or neutral point lead line 4 and a waveform 34 detected through the resistor 13 connected to the electrode 11 arranged concentrically with respect to the power line or neutral point lead line 4.

As is apparent from FIG. 12, the partial discharge pulse 33 propagated to the power line or neutral point lead line 4 induces, in the detection circuit including the electrode 11 and resistor 13, the pulse waveform 34 having a first wave of the same polarity as the first wave of the propagation pulse in the conductor.

It is possible to know that partial discharge pulse occurs in the stator winding by observing the pulse waveform of the same polarity as the first wave, which is displayed on the waveform observation device.

The cylindrical electrode 11 electrostatically coupled to the power line or neutral point lead line 4 arranged in the metal frame 5 and connected to the stator winding 6 is installed concentrically about the power line or neutral point lead line 4. The detector 3 receives and processes a high-frequency current flowing through the resistor 13 connected between the electrode 11 and the metal frame 5 (ground). Hence, the detector 3 can detect a partial discharge signal which is generated due to degradation of the stator winding. It is unnecessary to alter the interior of the electrical rotating machine. It is possible to relatively easily attach a non-contact sensor to a high-voltage unit by only altering the metal frame around the power line or neutral point lead line of the electrical rotating machine.

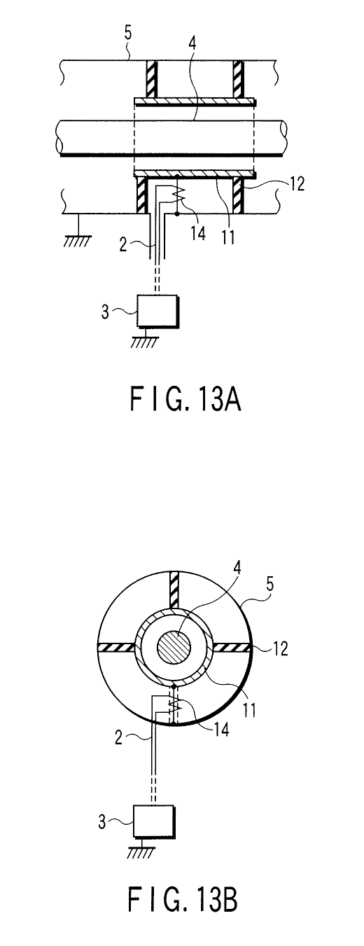

In the above embodiment, the detector 3 receives a high-frequency current flowing through the resistor 13 connected between the electrode 11 and the metal frame 5 (ground). Instead, as shown in FIGS. 13A and 13B, a high-frequency current transformer 14 may be inserted in the connection conductor that connects the electrode 11 and metal frame 5 (ground). The detector 3 may receive a high-frequency current detected by the high-frequency current transformer 14.

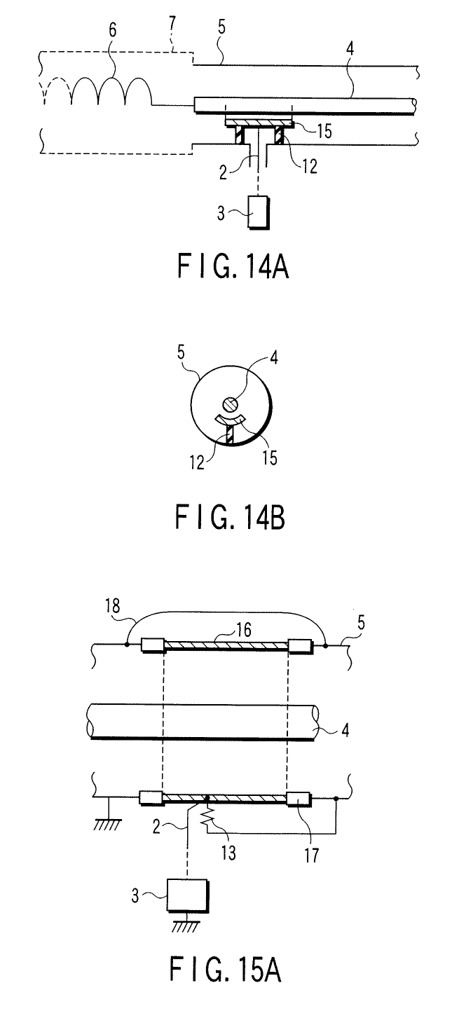

In the above embodiment, the cylindrical electrode 11 electrostatically coupled to the power line or neutral point lead line 4 is concentrically arranged about it. As shown in FIGS. 14A and 14B, it is also possible to divide the cylindrical electrode 11 in the axial direction into a plurality of divided electrodes 15 each having a circular shape and arrange the divided electrodes 15 concentrically about the power line or neutral point lead line 4. In this case, the plurality of divided electrodes 15 may be arranged in the longitudinal direction of the power line or neutral point lead line 4.

This arrangement allows to adjust the electrostatic capacitance between the high-frequency current transformer 14 and the divided electrodes 15 so that a signal in an optimum high-frequency band can be detected.

In the above embodiment, electrical stress is applied to the electrode surface. Hence, the electric field concentration may be moderated by covering the electrode surface with an insulating material such as epoxy or moderately processing the ends of the electrode.

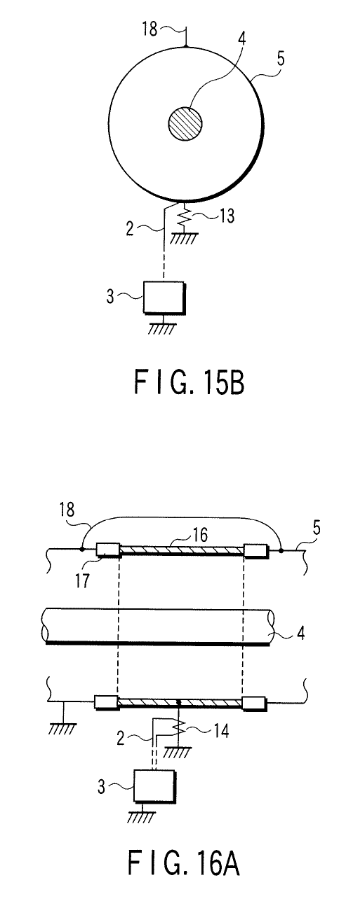

FIG. 15A is an axial sectional view showing a partial discharge detection apparatus of an electrical rotating machine according to the fourth embodiment of the present invention. FIG. 15B is a radial sectional view. The same reference numbers as in FIGS. 11A and 11B denote the same parts in FIGS. 15A and 15B.

In the fourth embodiment, as shown in FIGS. 15A and 15B, a metal frame 5 is radially cut and separated at a halfway point. A cylindrical electrode 16 having the same diameter as the metal frame is inserted to the separated point and arranged concentrically about a power line or neutral point lead line 4. The two open ends of the cylindrical electrode 16 are attached to the open ends of the separated metal frames 5 via ring-shaped electrode support insulating members 17. The ends of a connection conductor 18 arranged across the electrode 16 are connected to the separated metal frames 5, respectively.

A resistor 13 is connected between the electrode 16 and the metal frame 5. A signal lead line 2 is connected between the electrode-side terminal of the resistor 13 and a detector 3 which is arranged to receive a high-frequency current flowing through the resistor 13.

Even this arrangement allows to detect partial discharge on the basis of the same function as in the third embodiment. It is therefore unnecessary to alter the interior structure of the electrical rotating machine. It is possible to relatively easily attach a non-contact sensor to a high-voltage unit by only altering the metal frame around the power line or the neutral point lead line of the electrical rotating machine.

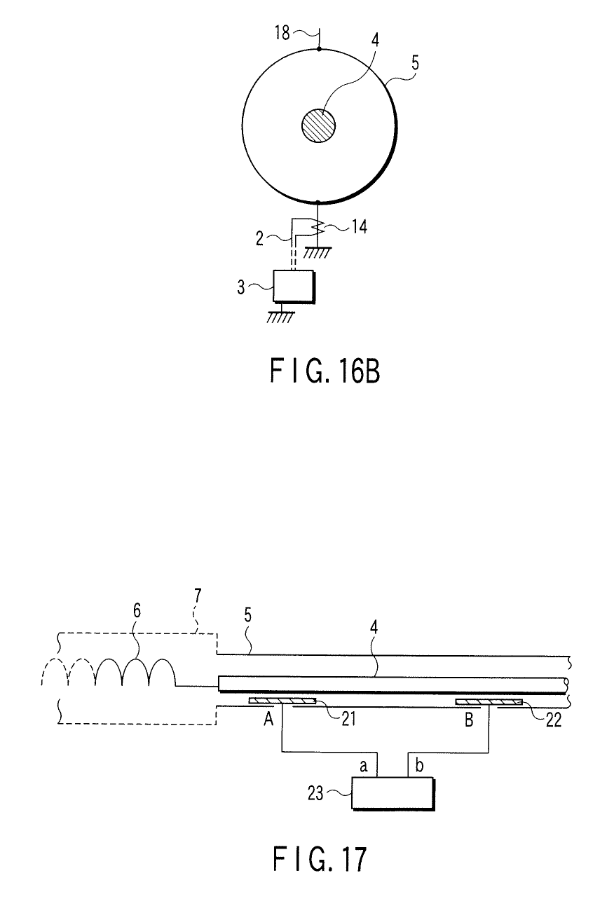

In the fourth embodiment, the detector 3 receives the high-frequency current flowing through the resistor 13 connected between the electrode 16 and the metal frame 5 (ground). Instead, as shown in FIGS. 16A and 16B, a high-frequency current transformer 14 may be coupled to a conductor connected between the electrode 16 and metal frame 5 (ground). The detector 3 may receive a high-frequency current detected by the high-frequency current transformer 14.

FIG. 17 is a view showing a partial discharge detection apparatus of an electrical rotating machine according to the fifth embodiment of the present invention. The same reference numbers as in FIGS. 1A and 1B denote the same parts in FIG. 17.

Referring to FIG. 17, a stator winding 6 corresponding to one phase of the three phases (FIG. 17 shows one phase) of the electrical rotating machine is stored in a slot formed in a stator core (not shown) attached to the inner surface of a stator frame 7.

A cylindrical metal frame 5 is attached to the stator frame 7. An insulating support (not shown) supports a power line 4 connected to the stator winding 6. The power line 4 is arranged on the central axis in the metal frame 5. Alternatively, an insulating support (not shown) supports a neutral point lead line 4 connected to the neutral point of the three-phase stator windings 6. The neutral point lead line 4 is arranged on the central axis in the metal frame 5.

For each phase of the power line or neutral point lead line 4, sensors 21 and 22 each including a rod antenna are installed in correspondence with the power line or neutral point lead line 4 at two points A and B spaced apart by a predetermined distance. A waveform comparator 23 receives the outputs from the sensors 21 and 22 and compares the waveforms. The result can be observed by using a waveform observation device.

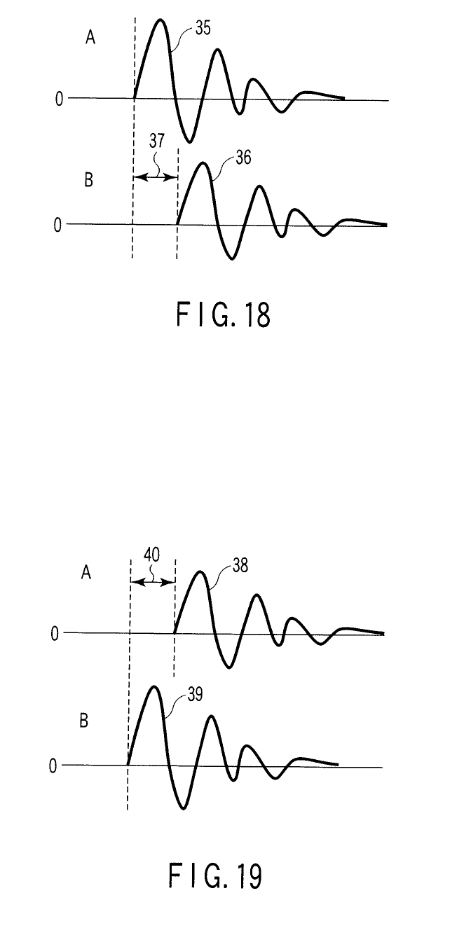

FIG. 18 shows waveforms that are obtained by connecting the sensors 21 and 22 to the waveform comparator 23 via detection leads with the same length and observing the outputs by using a simultaneous waveform observation device in the partial discharge detection apparatus with the above arrangement. FIG. 19 shows pulse waveforms that are obtained by detecting a pulse propagated in a direction to enter the electrical rotating machine from its opposite side. Referring to FIGS. 18 and 19, the abscissa represents the time, and the ordinate represents the waveform output (magnitude).

When a pulse is propagated from the electrical rotating machine to the power line or neutral point lead line 4, an output waveform 35 from the sensor 21 is observed first, and then an output waveform 36 from the sensor 22 is observed with a delay of several ns, as shown in FIG. 18. When a pulse is propagated from the power system to the power line or neutral point lead line 4, an output waveform 39 from the sensor 22 is observed first, and then an output waveform 38 from the sensor 21 is observed with a delay of several ns, as shown in FIG. 19.

Delay times 37 and 40 of several ns correspond to the pulse propagation time between the sensors 21 and 22. Hence, it is possible to estimate the pulse propagation direction by detecting the waveform arrival time lag 37 or 40 between the sensors 21 and 22.

The sensors 21 and 22 must be spaced apart by such a distance that allows to recognize the waveform time lag between them.

For example, a time width about ¼ the time width of the first half wave of the first leading edge pulse signal (e.g., 35) allows the waveform observation device to easily identify the arrival time lag. Hence, when the frequency of the pulse signal is 10 MHz, the necessary distance between the sensor installation points A and B is about 4 m.

The lower the frequency of a signal is, the longer the pulse waveform oscillation period is. To accurately detect the pulse waveform arrival time lags 37 and 40, the distance between the sensors 21 and 22 must be long.

Generally, a signal containing a partial discharge signal is propagated from the electrical rotating machine, while noise is mainly propagated from the power system side opposite the generator side. Hence, it is possible to separate noise from the power system by measuring the waveform arrival time lag between the sensors 21 and 22.

The above-described arrangement can improve the partial discharge detection sensitivity because the sensor 21 is close to the stator winding 6 serving as a partial discharge source.

Even when the signal lead lines connected to the sensors 21 and 22 have different lengths, correction can be done at the time of pulse detection if the lengths are known. Hence, it is possible to separate noise from the power system, as described above.

In this embodiment, for each phase of the power line or neutral point lead line 4, the sensors 21 and 22 are installed at two points spaced apart by a predetermined distance in the metal frame 5 that stores the power line or neutral point lead line 4 connected to the electrical rotating machine. Partial discharge is detected by measuring the arrival time lag between the output signal waveforms from the two sensors installed in the same phase. It is unnecessary to alter the interior of the electrical rotating machine. It is possible to relatively easily attach a non-contact sensor to a high-voltage unit by only altering the metal frame around the power line or neutral point lead line of the electrical rotating machine. In addition, the noise pulse from the power system can be separated from the pulse from the electrical rotating machine. Hence, it is possible to accurately detect partial discharge.

In the fifth embodiment, the two sensors 21 and 22 each including a rod antenna are installed. Two sensors each including a loop antenna or a plurality of rod antennas each having one end electrically connected may be installed.

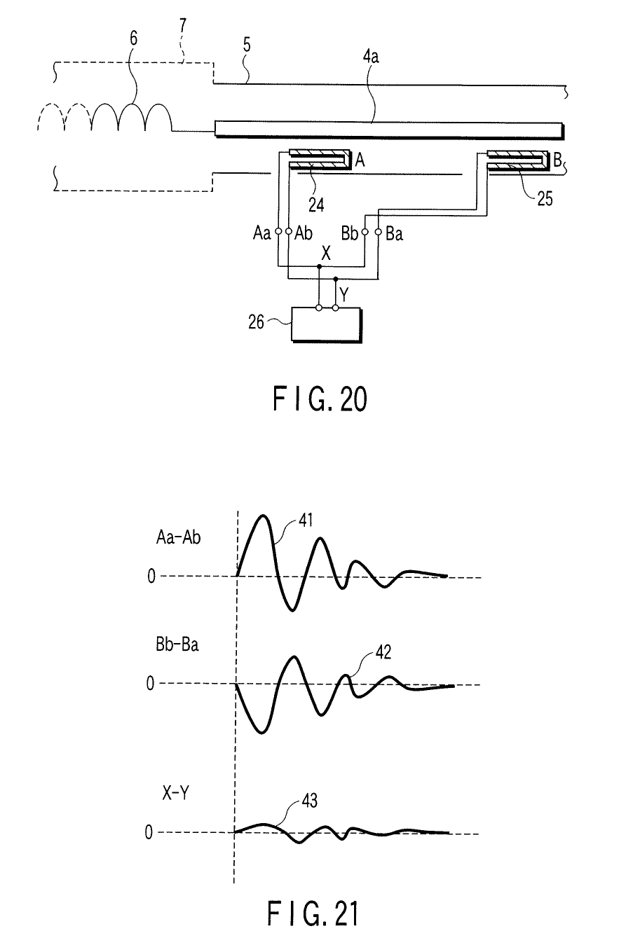

FIG. 20 is a view showing a partial discharge detection apparatus of an electrical rotating machine according to the sixth embodiment of the present invention. The same reference numbers as in FIGS. 1A and 1B denote the same parts in FIG. 20.

Referring to FIG. 20, a stator winding 6 corresponding to one phase of the three phases (FIG. 20 shows one phase) of the electrical rotating machine is stored in a slot formed in a stator core (not shown) attached to the inner surface of a stator frame 7.

A cylindrical metal frame 5 is attached to the stator frame 7. An insulating support (not shown) supports a conductor 4a such as an isolated-phase bus line, a coil connection conductor, or a neutral point lead line to which is propagated a partial discharge pulse signal. The conductor 4a is arranged on the central axis in the metal frame 5.

Two loop antennas 24 and 25 are arranged in the same direction along the conductor 4a at points A and B spaced apart by a predetermined distance. Terminals Aa and Ab and terminals Ba and Bb of signal lead lines connected to the loop antennas 24 and 25 are arranged in opposite directions so that the first wave peak values of the output waveforms from the signal lead lines of the loop antennas have opposite polarities.

Additionally, the length of the signal lead line connected to the loop antenna 25 far from the electrical rotating machine is set to be long such that the output waveform generated between the terminals Aa and Ab and that generated between the terminals Ba and Bb have the same timing when a pulse propagates through the conductor 4a in a direction to enter the electrical rotating machine. That is, the signal lead line of the loop antenna 25 is made long such that the signal propagation time of the signal lead line of the loop antenna 25 becomes longer than the signal propagation time of the signal lead line of the loop antenna 24 by the signal propagation time difference between the loop antennas 25 and 24.

The signal lead lines are connected to extract pulse voltages with opposite polarities corresponding to a single propagation pulse. A signal processor 26 receives a voltage signal obtained from common connection points X and Y as a sum of the pulse waveforms having opposite polarities. The result can be observed by using a waveform observation device.

FIG. 21 shows examples of output waveforms from the terminals Aa-Ab and Bb-Ba and a sum of the two waveforms when a signal is propagated in a direction to enter the electrical rotating machine in the partial discharge detection apparatus with the above arrangement.

Referring to FIG. 21, reference number 41 denotes a voltage waveform observed across the terminals Aa-Ab; 42, a voltage waveform observed across the terminals Ba-Bb; and 43, a sum waveform of the voltage waveforms 41 and 42.

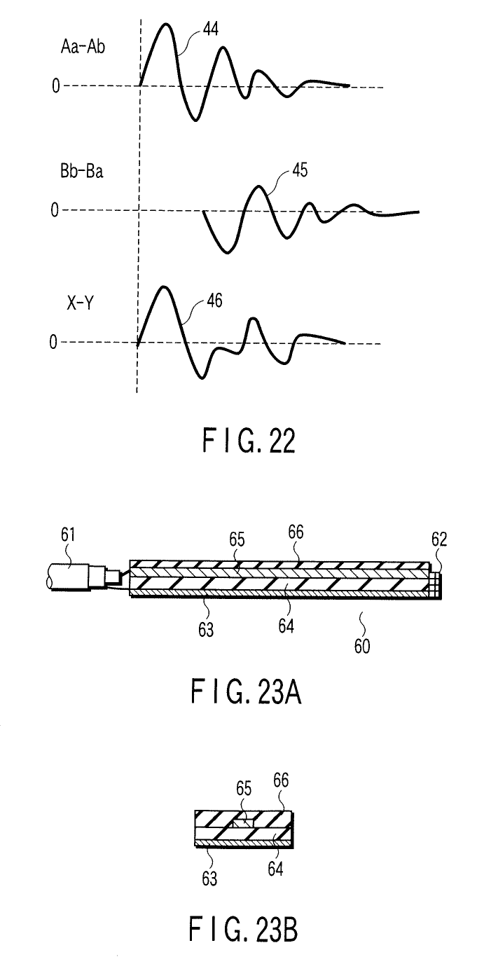

FIG. 22 shows examples of output waveforms observed at the terminals Aa-Ab and Ba-Bb and a sum of the two waveforms when a signal is propagated from the electrical rotating machine to the outside.

Referring to FIG. 22, reference number 44 denotes a voltage waveform observed at the terminals Aa-Ab; 45, a voltage waveform observed at the terminals Ba-Bb; and 46, a sum waveform of the voltage waveforms 44 and 45.

As shown in FIG. 22, the waveform sum of the loop antennas 24 and 25 holds the first half wave peak value of the pulse waveform propagated from the electrical rotating machine. However, the first half wave peak value of the pulse waveform propagated in the direction to enter the electrical rotating machine is canceled.

To hold the first half wave of the waveform sum 46 shown in FIG. 22 when the pulse is propagated from the electrical rotating machine to the outside, the loop antennas 24 and 25 must have a distance corresponding to the time width of the first half wave of the waveform sum 46.

For example, when the frequency of the pulse signal (e.g., the waveform 41 in FIG. 21) is 10 MHz, the necessary distance between the loop antennas 24 and 25 is about 7 m. Generally, a signal containing a partial discharge signal is propagated from the electrical rotating machine, while noise is mainly propagated from the power system. Hence, it is possible to separate noise propagated from the system.

In the above embodiment, the terminals Aa and Ab and terminals Ba and Bb of the signal lead lines connected to the two loop antennas 24 and 25 arranged in the same direction are arranged in opposite directions so that the first wave peak values of the output waveforms from the signal lead lines of the loop antennas have opposite polarities. Instead, the loop antennas 24 and 25 may be arranged in opposite directions to induce voltages in opposite directions.

As described above, in this embodiment, the loop antennas 24 and 25 are spaced apart by a predetermined distance and arranged in the metal frame 5 that stores the conductor 4a such as the isolated-phase bus line, a coil connection conductor, or a neutral point lead line of the electrical rotating machine to propagate a partial discharge pulse signal. The signal lead lines from the antennas are arranged so that the peak values of the output pulse waveforms obtained from the signal lead lines connected to the antennas have opposite polarities. The arrangement is adjusted such that a pulse output to the signal lead line terminal connected to the antenna far from the stator winding of the electrical rotating machine and a pulse output to the signal lead line terminal connected to the antenna close to the stator winding of the electrical rotating machine arrive at the same timing. The signal processor 26 receives the pulse signals induced in the two antennas and detects the sum of the pulse waveforms. It is unnecessary to alter the interior arrangement of the electrical rotating machine. It is possible to relatively easily attach a non-contact sensor to a high-voltage unit by only altering the metal frame around the conductor 4a. In addition, it is possible to increase the detection sensitivity.

In the sixth embodiment, the two loop antennas 24 and 25 are installed. Two sets of a plurality of loop antennas connected in series may be installed. Even this arrangement can produce the same function and effect as described above.

FIG. 23A is a longitudinal sectional view showing the structure of a microstrip antenna serving as a sensor used in a partial discharge detection apparatus of an electrical rotating machine according to the seventh embodiment of the present invention. FIG. 23B is a cross-sectional view.

Referring to FIGS. 23A and 23B, a coaxial cable 61 has a characteristic impedance of 50 Ω. The coaxial cable 61 includes a flat plate part and a resistive terminator 62 of 50 Ω. The flat plate part has a three-layer structure including an insulation 64 and transmission line 65 formed on a plate electrode 63. An insulating layer 66 covers the structure.

The characteristic impedance between the transmission line 65 and the plate electrode 63, which is determined from the geometric arrangement, is 50 Ω, i.e., equals to that of the terminator 62.

As the signal lead line is used a coaxial cable with a characteristic impedance of 50 Ω. The transmission line 65 of the flat plate is connected to the central line of the coaxial cable 60. The plate electrode 63 is connected to a coaxial cable shield line.

The coaxial cable used as the signal lead line prevents noise mixing from the ambient part except the antenna.

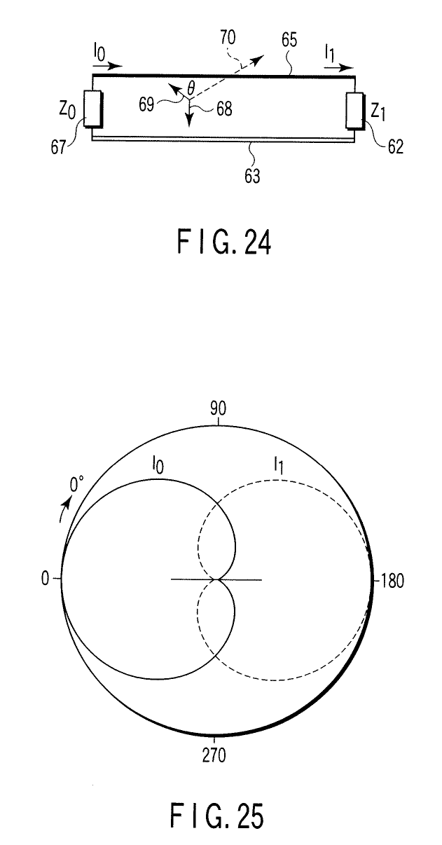

FIG. 24 shows an equivalent circuit of the microstrip antenna shown in FIGS. 23A and 23B.

Referring to FIG. 24, reference number 67 denotes a characteristic impedance of the coaxial cable; 68, an electric field component of an electromagnetic wave; and 69, a magnetic field component of an electromagnetic wave. The angle made by the transmission line 65 and a traveling direction 70 of the electromagnetic wave propagated through the space is represented by θ.

FIG. 25 shows the directivities of currents I₀ and I₁ which are generated in the microstrip antenna by the electromagnetic wave propagated in the space.

The sensitivity of the microstrip end current I₀ generated in the coaxial cable 61 is maximized when the angle made by the transmission line 65 with respect to the electromagnetic wave traveling direction is 0°. In other words, the output of the coaxial cable is maximized with respect to the electromagnetic wave propagated from the direction of the coaxial cable 61.

In the stator frame of the electrical rotating machine or in the space inside the metal frame storing the power line connected to the stator winding or neutral point lead line connected to the stator windings of the electrical rotating machine, an electromagnetic wave is propagated upon occurrence of partial discharge on the stator winding.

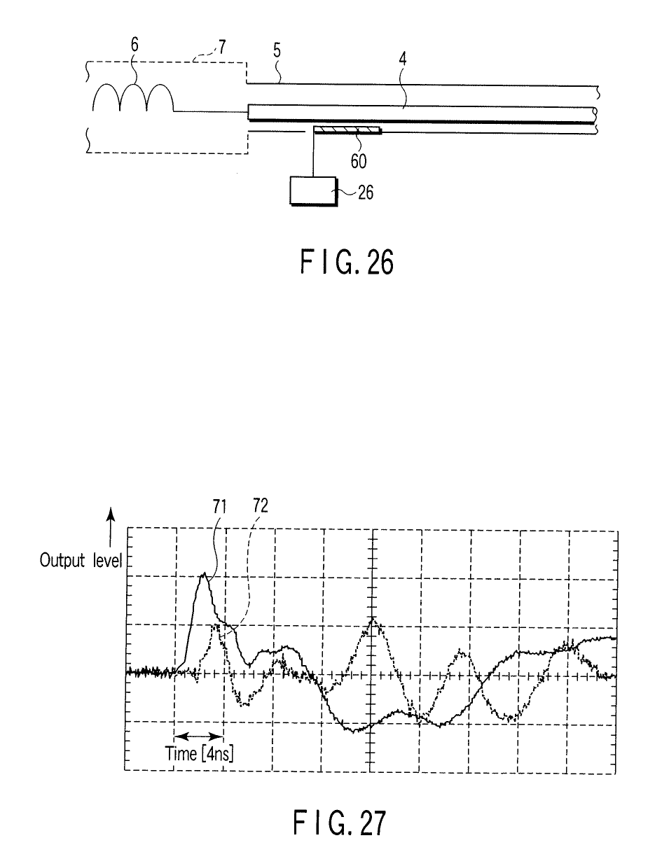

It is therefore possible to detect a partial discharge signal with high sensitivity by installing the microstrip antenna 60 having the above-described structure on the inner surface of the metal frame 5 along the direction of the stator winding, as shown in FIG. 26.

FIG. 27 is a waveform chart showing waveforms obtained by installing the above-described microstrip antenna 60 between a high-voltage conductor and a metal frame and detecting partial discharge of the stator winding.

As is apparent from the waveforms shown in FIG. 27, a partial discharge signal can be detected because a partial discharge pulse signal 71 generates a pulse waveform 72 in the coaxial cable connected to the antenna.

If the frame 7 or metal frame 5 of the electrical rotating machine has a portion where an electromagnetic wave leaks to the outside, partial discharge can be detected by installing a microstrip line on the outer surface of the frame near that portion.

As described above, in this embodiment, partial discharge can be detected by installing the microstrip antenna 60 having one side connected to the resistive terminator 62 and including the plate electrode 63, insulation 64, and transmission line 65 on the inner or outer surface of the stator frame of the electrical rotating machine or on the inner or outer surface of the metal frame that stores the power line or neutral point lead line connected to the stator winding of the electrical rotating machine. It is unnecessary to alter the interior of the electrical rotating machine. It is possible to relatively easily attach a non-contact sensor to a high-voltage unit by only altering the metal frame around the power line or neutral point lead line of the electrical rotating machine.

In the seventh embodiment, using the directivity of an antenna, a plurality of microstrip antennas 60 may be installed in the metal frame or the stator frame of the electrical rotating machine. When partial discharge occurs due to degradation of the stator winding, an electromagnetic wave is propagated through the space between the stator winding and the stator frame. The partial discharge source may be specified by comparing the intensities of signals output from the antennas detecting the electromagnetic wave.

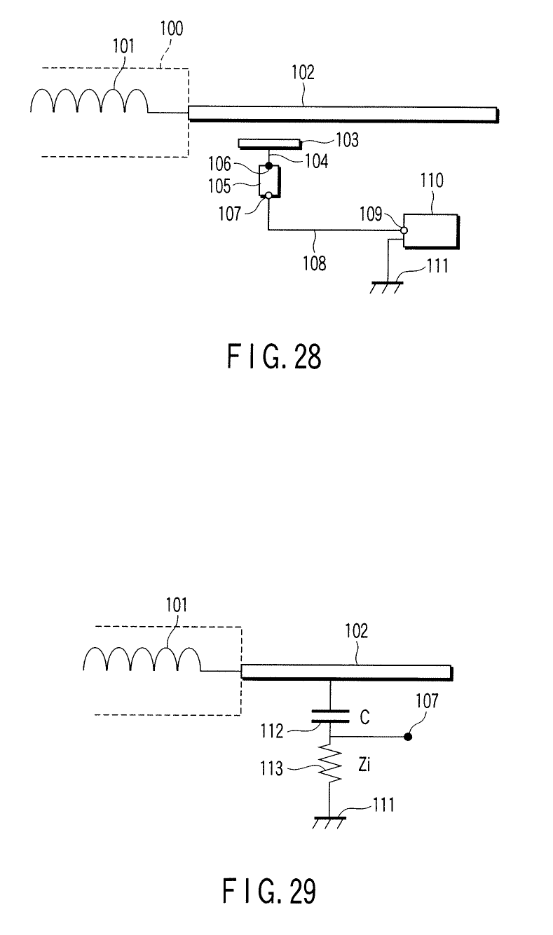

FIG. 28 is a view showing a partial discharge detection apparatus of an electrical rotating machine according to the eighth embodiment of the present invention.

Referring to FIG. 28, a stator winding or winding 101 corresponding to one phase of the three phases (FIG. 28 shows one phase) of the electrical rotating machine is stored in a slot formed in a stator core (not shown) attached to the inner surface of a stator frame 100. A power line 102 is connected to the stator winding 101 of each phase. Alternatively, a neutral point lead line 102 may be connected to the neutral point of the three-phase stator windings. A support member (not shown) supports a non-contact electrical conductive element 103 which is made of copper or aluminum and electrostatically coupled to the power line or neutral point lead line 102.

An input terminal 106 of an impedance converter 105, in which at least an input impedance Zin is higher than an output impedance Zout, is electrically connected to the electrical conductive element 103 via a lead line 104. A partial discharge pulse signal is detected by inputting a detection signal from an output terminal 109 of a transmission line 108 (characteristic impedance Z₀) to a signal processor 110. The output terminal 109 is connected to an output terminal 107 of the impedance converter 105 so as to match the impedances.

As the transmission line 108 is generally used a coaxial cable having a characteristic impedance of 50 Ω or 75 Ω. Hence, Zout is often 50 Ω or 75 Ω.

The function of the partial discharge detection apparatus of the electrical rotating machine with the above arrangement will be described next.

FIG. 29 shows an electrical equivalent circuit viewed from the power line or neutral point lead line 102 in FIG. 28. The power line or neutral point lead line 102 is connected in series to an electrostatic capacitance C and an input impedance Zi of the impedance converter 105 and grounded to a ground point 111. The ratio of an output Vo from the output terminal 107 of the impedance converter 105 to an AC voltage peak value Vi flowing to the power line or neutral point lead line 102 is given by
Vₒ/Vᵢ=1/\sqrt{{1+[1/(2πfCZᵢₙ)]²}} (1)

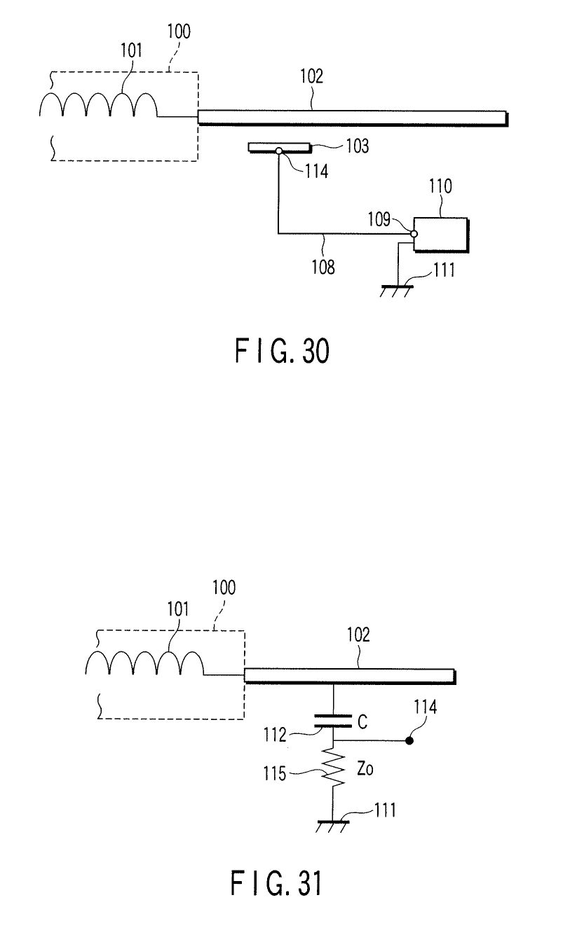

FIG. 30 shows an arrangement which is configured to connect the transmission line 108 having the characteristic impedance Z₀ directly to the electrical conductive element 103 without using the impedance converter.

FIG. 31 shows an electrical equivalent circuit configured by connecting the electrostatic capacitance C and characteristic impedance Z₀ in series in FIG. 30. The ratio of the output Vo from the detection terminal 114 to the AC voltage peak value Vi flowing to the power line or neutral point lead line 102 is given by
Vₒ/Vᵢ=1/\sqrt{{1+[1/(2πfCZ₀)]²}} (2)

As the transmission line 108 is generally used a coaxial cable having a characteristic impedance of 50 Ω or 75 Ω.

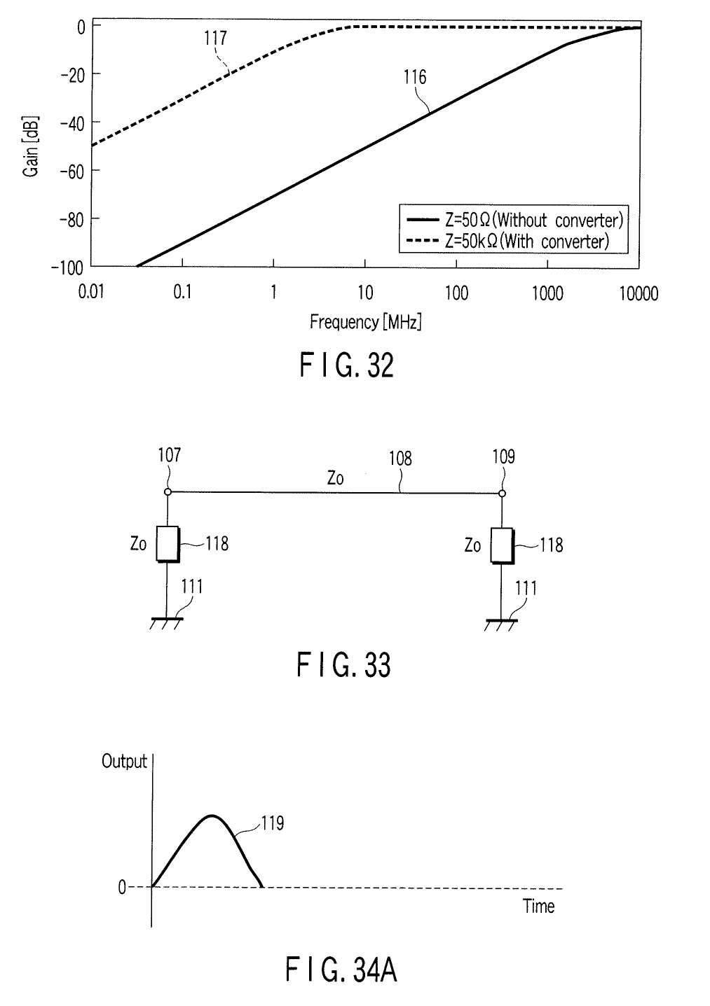

FIG. 32 shows a frequency characteristic 117 (20*Log(Vo/Vin)) in FIGS. 28 and 29 which is obtained by using the impedance converter having the input impedance Zin higher than Zout and setting C=1 pF, Zin=50 kΩ, and Zout =50 Ω, and a frequency characteristic 116 in FIGS. 30 and 31 which is obtained by setting C=1 pF and Z₀=50 Ω without using an impedance converter.

Where an electrostatic capacitance and an impedance form a high-pass filter.

As is apparent from FIG. 32, the output gain is larger in the detection method shown in FIG. 28 that uses the impedance converter 105 connected to the electrical conductive element 103 than in the detection method shown in FIG. 30 that uses no impedance converter.

FIG. 33 shows an electrical equivalent circuit viewed from the signal processor 110 in FIG. 28. Resistance values (Z₀) 118 equal to the characteristic impedance Z₀ terminate the two terminals of the transmission line 108 to prevent the terminals 107 and 109 from reflecting a signal propagated in the transmission line 108.

FIGS. 34A and 34B are waveform charts showing the effect of preventing reflection at the terminals. FIG. 34A shows a voltage signal waveform 119 obtained from the terminal 109 when the terminators (Z₀) 118 equal to the characteristic impedance Z₀ terminate the two terminals 107 and 109 of the transmission line 108.

FIG. 34B shows a waveform 122 obtained from the terminal 109 when the terminators 118 are removed from the two terminals of the transmission line 108 to open it. The waveform 122 is the sum of a waveform 120 obtained by directly inputting, to the terminal 109, a waveform output from the terminal 107 and a voltage waveform 121 which appears at the terminal 109 after a time T during which the waveform is totally reflected by the terminal 109, propagated through the transmission line 108, reflected again by the terminal 107, and propagated through the transmission line 108. Depending on the length of the transmission line 108, the propagation time T shortens, and an output waveform largely different from an original waveform 120 is generated.

That is, when the output impedance Zout of the impedance converter 105, the characteristic impedance Z₀ of the transmission line 108, and the input impedance of the signal processor 110 shown in FIG. 28 are set equal (Zout=Z₀), the waveform can accurately be transmitted to the signal processor 110.

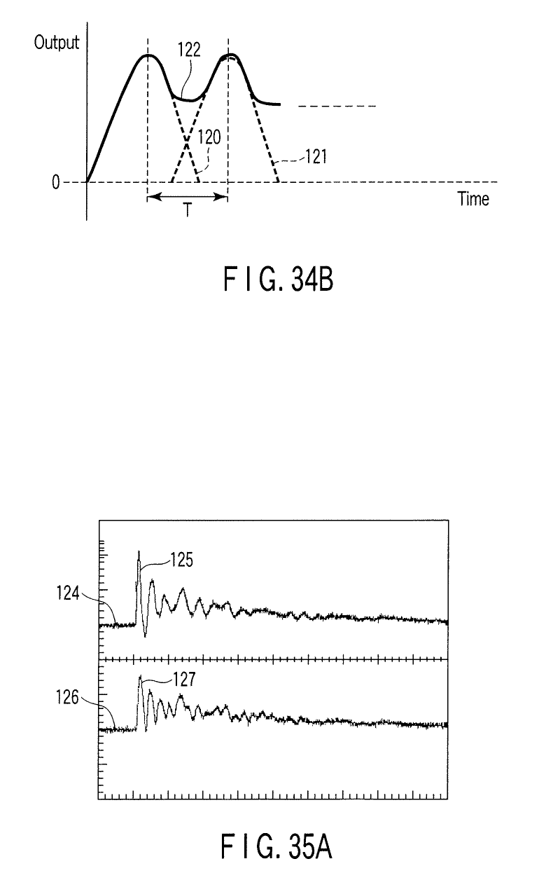

FIG. 35A shows an example of a partial discharge pulse observed by using the detection method in FIG. 28. Reference number 124 in FIG. 35A indicates the partial discharge signal 125 flowing to the power line, and 126 indicates a signal output to the transmission line end 108. In FIG. 35A, a partial discharge pulse waveform 127 can accurately be detected. FIG. 35B shows an example of a partial discharge pulse observed by using the detection method in FIG. 30. Reference number 128 in FIG. 35B indicates a partial discharge signal 129 flowing to the power line, and 130 indicates an output signal from the transmission line end the pulse peak value of which is smaller than the partial discharge signal 129.

In the above embodiment, an electrical conductive element electrostatically coupled to the power line or neutral point lead line 102 connected to the stator winding of the electrical rotating machine is provided in a non-contact state. Even by providing a capacitor connected to the power line or neutral point lead line 102 in place of the electrical conductive element, partial discharge can be detected as described above.

In the partial discharge detection apparatus of the electrical rotating machine according to the eighth embodiment, one terminal of the electrical conductive element 103 which is electrostatically coupled to the power line 102 connected to the stator winding corresponding to one phase of the three phases of the electrical rotating machine or the neutral point lead line 102 connected to the neutral point of the three-phase stator windings and which is in a non-contact state with respect to the power line or neutral point lead line 102, or one end of a capacitor connected to the power line or neutral point lead line 102 are electrically connected to the input terminal of the impedance converter with the input impedance higher than the output impedance. A partial discharge pulse signal is detected from the output terminal of the impedance converter or the output terminal of a transmission circuit connected to the output terminal of the impedance converter so as to match the impedances. It is unnecessary to alter the interior of the electrical rotating machine. It is possible to relatively easily attach a non-contact sensor to a high-voltage unit by only altering the metal frame around the power line or the neutral point lead line of the electrical rotating machine. In addition, partial discharge can be detected at a high detection sensitivity and accuracy.

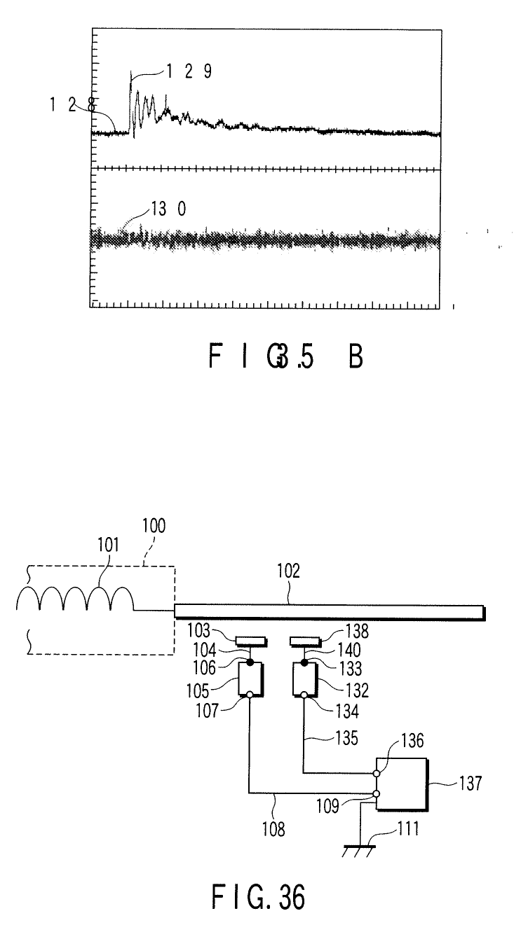

FIG. 36 is a view showing a partial discharge detection apparatus of an electrical rotating machine according to the ninth embodiment of the present invention.

Referring to FIG. 36, a power line 102 is connected to a stator winding 101 corresponding to one phase of the three phases of the electrical rotating machine. Alternatively, a neutral point lead line 102 may be connected to the neutral point of the three-phase stator windings 101. At least two electrical conductive elements 103 and 138 which have an electrostatic coupling of equal or different capacitances with the power line or neutral point lead line 102 and are in non-contact with the power line or neutral point lead line 102 are electrically connected via lead lines 104 and 140 to input terminals 106 and 133 of two impedance converters 105 and 132, which have different input impedance values and in which at least the input impedance is higher than the output impedance. A partial discharge pulse signal is detected by inputting detection signals to a signal processor 137 from output terminals 109 and 136 of transmission lines 108 and 135 which are connected to output terminals 107 and 134 of the impedance converters 105 and 132 so as to match the impedances.

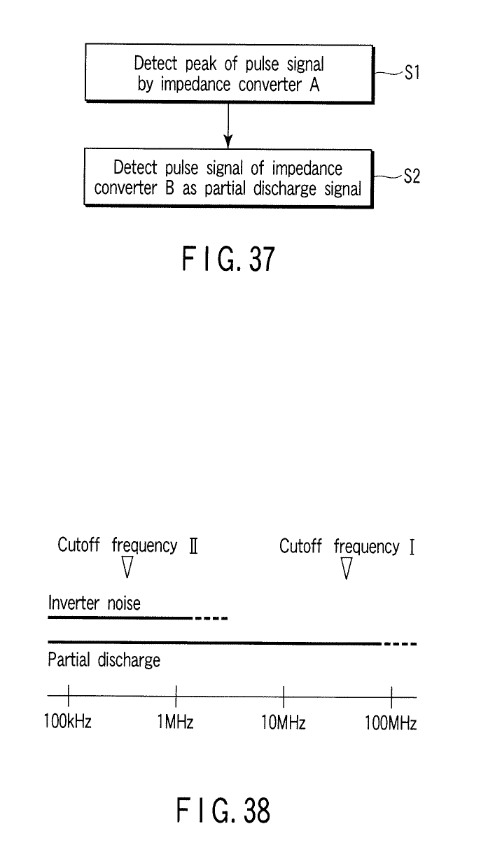

As shown in FIG. 37, the signal processor 137 has a function (S1) of determining the peak detection timing of a pulse signal output from the output terminal 107 of the impedance converter 105 having a small input impedance value, and a function (S2) of determining, as a partial discharge signal, a pulse signal output from the output terminal 134 of the impedance converter 132 having a large input impedance value.

FIG. 38 shows an inverter noise that is supposed to be a noise factor upon partial discharge detection and the generation frequency band of a partial discharge waveform in the electrical rotating machine. The inverter noise generally includes a frequency up to several MHz. While, partial discharge signal includes a frequency of several MHz or more.

An input impedance Zin and electrostatic capacitance C of the impedance converter 105 form a high-pass filter to pass only the high-frequency component of a signal, as shown in FIG. 32. A cutoff frequency fc of the high-pass filter is given by
fc=½πZᵢₙC (3)

When the input impedance value of the impedance converter 105 is selected such that a cutoff frequency I exists in a band of at least 10 MHz where only partial discharge signal component is present, only a partial discharge pulse is output from the output terminal 107 of the impedance converter 105 shown in FIG. 38.

As shown in FIG. 38, however, a partial discharge sometimes includes a wide frequency component in one pulse. Hence, it is impossible to reproduce accurate discharge waveform flowing in the power line by the outputs of the impedance converter 105. When a low cutoff frequency (cutoff frequency II) is set up to the band where noise exists, as shown in FIG. 38, an accurate partial discharge waveform can be detected.

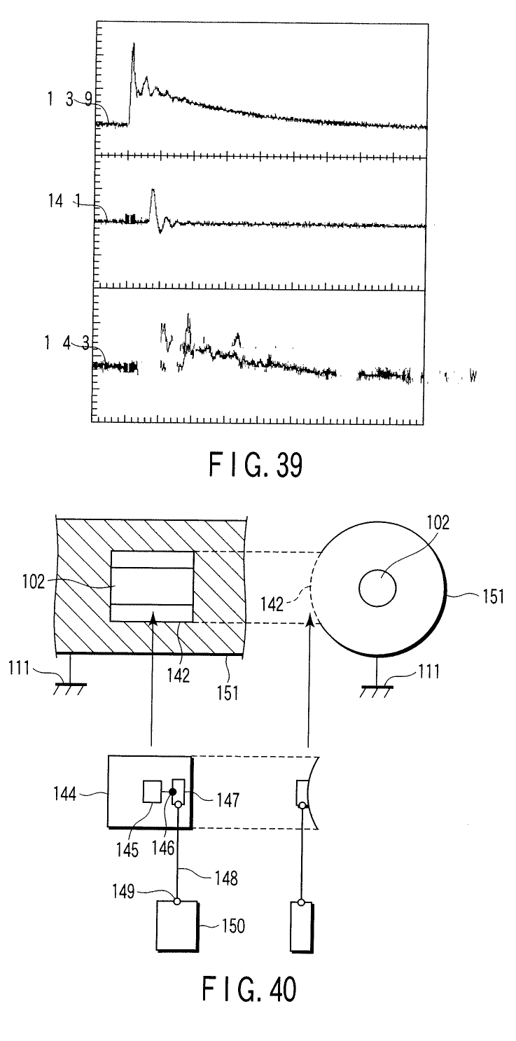

FIG. 39 shows a partial discharge signal 139 flowing to the power line, a waveform 141 that appears at the output terminal 109 of the transmission line 108 of the impedance converter 105 whose impedance is selected so as to make the cutoff frequency I exist in the band in which only partial discharge is generated, and a waveform 143 that appears at the output terminal 136 of the transmission line of the impedance converter 132 having the cutoff frequency II existing in a low-frequency band containing noise.

As is apparent from FIG. 39, the output terminal 107 of the impedance converter 105 outputs the partial discharge waveform 141 containing only the high-frequency component of partial discharge. The output terminal 134 of the impedance converter 132 accurately outputs the partial discharge waveform 143.

However, since the low-frequency region contains inverter noise at a high probability, as shown in FIG. 38, a noise detection error occurs.

The signal processor 137 receives a waveform detected by the impedance converter 132 having a low cutoff frequency by using, as a trigger, generation of a partial discharge waveform detected by the impedance converter 105 having a cutoff frequency to detect only the frequency band of partial discharge, as shown in FIG. 37. This allows to remove the noise and accurately receive the partial discharge waveform.

In the above embodiment, the two electrical conductive elements 103 and 138 electrostatically coupled to the power line 102 connected to the stator winding of the electrical rotating machine or neutral point lead line 102 are provided in a non-contact state. Even by providing capacitors connected to the power line or neutral point lead line 102 in place of the electrical conductive elements 103 and 138, it is possible to remove noise and accurately receive a partial discharge waveform, in the similar way as described above.

In the ninth embodiment of the present invention, a power line is connected to the stator winding corresponding to one phase of the three phases of the electrical rotating machine. Alternatively, a neutral point lead line may be connected to the neutral point of the three-phase stator windings. Each of at least two electrical conductive elements which have an electrostatic coupling of equal or different capacitances with the power line or neutral point lead line and are in non-contact with the power line or neutral point lead line or each of at least two capacitors connected to the power line or neutral point lead line is electrically connected to a corresponding one of the input terminals of two impedance converters, which have different input impedance values and in which the input impedance is higher than the output impedance. A pulse signal generated from the output terminal of one of the two impedance converters, which has a large input impedance value, at the same timing with the peak detection timing of a pulse signal at the output terminal of the impedance converter having a small input impedance value is determined as a partial discharge signal. It is unnecessary to alter the interior of the electrical rotating machine. It is possible to relatively easily attach a non-contact sensor to a high-voltage unit by only altering the metal frame around the power line or the neutral point lead line of the electrical rotating machine. In addition, partial discharge can be detected at a high detection sensitivity and accuracy.

FIG. 40 is a view showing a partial discharge detection apparatus of an electrical rotating machine according to the 10th embodiment of the present invention.

Referring to FIG. 40, a power line 102 is connected to a stator winding corresponding to one phase of the three phases of the electrical rotating machine or a neutral point lead line 102 is connected to the neutral point of the three-phase stator windings. An electrical conductive frame 151 having a rectangular parallelepiped shape or cylindrical shape is arranged around the power line or neutral point lead line 102.

The electrical conductive frame 151 has an inspection window 142. A flat or circular insulating plate 144 is fixed to the inspection window 142. The obverse surface or reverse surface of the insulating plate 144 supports an electrical conductive element 145 which is electrostatically coupled to the power line or neutral point lead line 102 and is in non-contact with the power line or neutral point lead line 102. Further, an impedance converter 147 in which at least the input impedance is higher than the output impedance is supported on the insulating plate 144. The impedance converter 147 is connected to a signal processor 150 via a transmission line 148.

The impedance converter 147 selected in accordance with the frequency band to be detected is connected to the electrical conductive element 145 electrostatically coupled to the power line or neutral point lead line 102 to form, on the obverse surface or reverse surface of the insulating plate 144 fixed to the inspection window 142 of the electrical conductive frame 151, a high-pass filter represented by the electrical equivalent circuit shown in FIGS. 29 and 31. This allows to detect a partial discharge pulse.

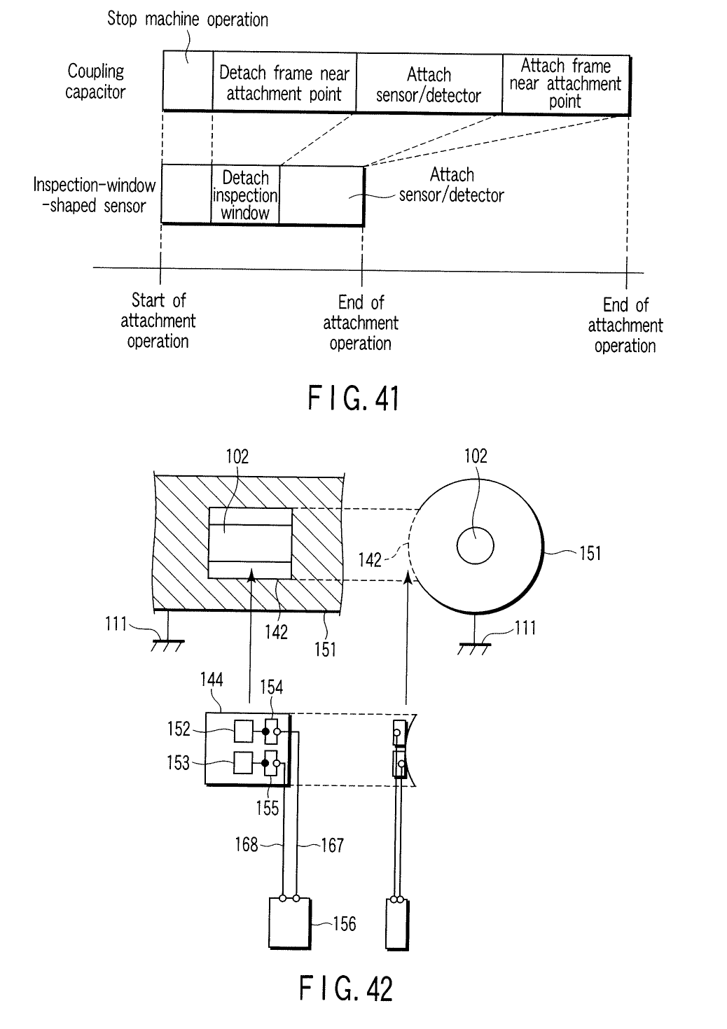

FIG. 41 shows the procedure and time required for attaching the partial discharge detection apparatus. A coupling capacitor as a conventional sensor is often installed in the frame as a partial discharge detection sensor in the conventional method. To attach this sensor to the electrical rotating machine during operation, procedures of stopping the operation of the electrical rotating machine, detaching the frame near the attachment point, attaching the sensor and circuits, and re-attaching the frame near the attachment point are necessary.

In the arrangement shown in FIG. 40, however, the insulating plate 144 that supports the electrical conductive element 145 and impedance converter 147 is fitted in the opening of the inspection window. To attach the sensor, procedures of stopping the electrical rotating machine, detaching the insulating plate 144 from the inspection window, and attaching the insulating plate 144 to the opening of the inspection window are necessary suffice. This can simplify the procedure and shorten the attachment time as compared to the conventional method.

As described above, in the 10th embodiment of the present invention, the electrical conductive frame 151 having a rectangular parallelepiped shape or cylindrical shape and an inspection window is arranged around the stator winding of the electrical rotating machine. The opening of the inspection window of the electrical conductive frame 151 detachably supports the insulating plate 144 on which the electrical conductive element 145 in non-contact with the power line or neutral point lead line 102 and the impedance converter 147 connected to the electrical conductive element 145 and having the input impedance higher than the output impedance are fixed. Hence, the partial discharge detection unit can easily be attached in a short time.

In the 10th embodiment, the electrical conductive frame 151 is arranged around the power line or neutral point lead line 102, as shown in FIG. 40. In, e.g., an electric power generator having the power line or neutral point lead line 102 and a grounded frame structure, providing the detection electrical conductive element 145 in the frame covering the power line or neutral point lead line 102 may degrade the insulating properties. To prevent this, the electrical conductive element 145 is installed on the inspection window 142 of the frame.

In this case, the distance between the electrical conductive element 145 and the power line or neutral point lead line 102 is about several decimeters, although it depends on the device. The size of the inspection window 142 is several decimeters×several decimeters. Hence, an electrostatic capacitance C is approximately 1 pF on the basis of (dielectric constant 8.85 pF/m× estimated area of electrical conductive element facing the power line 0.1×0.1 m²/distance between electrical conductive element and power line 0.1 m).

Assume that an input impedance Zin of the impedance converter 147 connected to the electrical conductive element 145 having the electrostatic coupling mentioned as above is 50,000 Ω or more. The cutoff frequency is about 3 MHz from equation (3). For this reason, accurate partial discharge detection free from the influence of noise is possible in a detection band corresponding to a frequency band of several MHz where inverter noise decreases, as shown in FIG. 38.

In the partial discharge detection method shown in FIG. 40, the inspection window 142 may be large, or the distance between the electrical conductive element 145 and the power line 102 may be short in some cases. If the electrostatic coupling is assumed to be up to 10 pF, a cutoff frequency of about 3 MHz can be obtained by setting the input impedance of the impedance converter 147 to 5,000 Ω or more.

As the transmission line 148 is often used a coaxial cable having a characteristic impedance of 50 Ω or 75 Ω. For impedance matching, the output impedance of the impedance converter 147 is set to 50 Ω or 75 Ω.

As described above, the power line 102 is connected to the stator winding corresponding to one phase of the three phases of the electrical rotating machine. Alternatively, the neutral point lead line 102 may be connected to the neutral point of the three-phase stator windings. An electrical conductive element which has an electrostatic coupling of 10 pF or less with the power line or neutral point lead line 102 and is in non-contact with the power line or neutral point lead line is electrically connected to the input terminal of an impedance converter having an input impedance of 5,000 Ω or more. A partial discharge pulse signal is detected from the output terminal of the impedance converter having an output impedance of 50 Ω or 75 Ω or from the output terminal of a transmission circuit which has a characteristic impedance of 50 Ω or 75 Ω and which is connected to the output terminal of the impedance converter so as to match the impedances. This enables partial discharge detection at a high detection sensitivity and accuracy.

Even in this embodiment, it is possible to remove noise and accurately receive a partial discharge waveform, as described above, by providing a capacitor in place of the electrical conductive element 145.

FIG. 42 is a view showing a partial discharge detection apparatus of an electrical rotating machine according to the 13th embodiment of the present invention.

As shown in FIG. 42, in, e.g., an electric power generator having a power line or neutral point lead line 102 and an electrical conductive frame 151, providing a plurality of detection electrical conductive elements 152 and 153 in the frame 151 covering the power line or neutral point lead line 102 may degrade the insulating properties. To prevent this, the plurality of detection electrical conductive elements 152 and 153 are installed on an inspection window 142 of the frame.

In this case, the distance between the detection electrical conductive elements 152 and 153 and the power line or neutral point lead line 102 is about several decimeters, although it depends on the device. The size of the inspection window 142 is several decimeters×several decimeters. Hence, an electrostatic capacitance C is approximately 1 pF on the basis of (dielectric constant 8.85 pF/m×estimated area of electrical conductive element facing the power line 0.1×0.1 m²/distance between electrical conductive element and power line 0.1 m).

Assume that an input impedance Zin of an impedance converter 154 connected to the detection electrical conductive element 152 is 50,000 Ω or more. The cutoff frequency is about 3 MHz from equation (3). For this reason, partial discharge detection free from the influence of noise is possible in a detection band corresponding to a frequency band of several MHz or more where inverter noise decreases, as shown in FIG. 38.

However, since one pulse of partial discharge may have a frequency component of several MHz or less where noise is generated, the converter cannot perfectly reproduce the partial discharge pulse flowing to the power line 102 in some cases.

When a cutoff frequency (cutoff frequency II) is set to the lower band where noise exists, as shown in FIG. 38, an accurate partial discharge waveform can be detected. When the input impedance Zin of an impedance converter 155 connected to the other detection electrical conductive element 153 having an electrostatic coupling of about 1 pF with the power line or neutral point lead line 102 is 500,000 Ω, the cutoff frequency is 300 kHz. The impedance converter 155 can accurately output the whole partial discharge waveform.

In the method shown in FIG. 40, the inspection window 142 may be large, or the distance between the detection electrical conductive elements 152 and 153 and the power line 102 may be short in some cases. Assume that the electrostatic coupling is up to 10 pF. To set the cutoff frequency of the output signal from the impedance converter 154 to about 3 MHz, the input impedance of the impedance converter 154 is set to 5,000 Ω or more. To set the cutoff frequency of the output signal from the impedance converter 155 to 300 kHz or more, the input impedance of the impedance converter 155 may be set to 50,000 Ω or more.

As transmission lines 167 and 168 is often used a coaxial cable having a characteristic impedance of 50 Ω or 75 Ω. For impedance matching, the output impedance of the impedance converters 154 and 155 is set to 50 Ω or 75 Ω.

As described above, in the 11th embodiment of the present invention, the partial discharge detection apparatus comprises the two detection electrical conductive elements 152 and 153 which have an electrostatic coupling of 10 pF or less with the power line or neutral point lead line connected to the stator winding of the electrical rotating machine and are in non-contact with the power line or neutral point lead line, the impedance converter 154 having an input impedance value of 5,000 Ω or more and an output impedance value of 50 Ω or 75 Ω, and the impedance converter 155 having an input impedance value of 50,000 Ω or more, i.e., an input impedance value larger than the impedance converter 154 and an output impedance value of 50 Ω or 75 Ω. The detection electrical conductive element 152 is electrically connected to the input terminal of the impedance converter 154. The other detection electrical conductive element 153 is electrically connected to the impedance converter 155. A pulse signal that is generated from the output terminal of the impedance converter 155 simultaneously with the peak detection timing of a pulse signal at the output terminal of the impedance converter 154 is determined as a partial discharge signal. This enables partial discharge detection at a high detection sensitivity and accuracy.

Even in this embodiment, it is possible to remove noise and accurately receive a partial discharge waveform, as described above, by providing two capacitors in place of the detection electrical conductive elements 152 and 153.

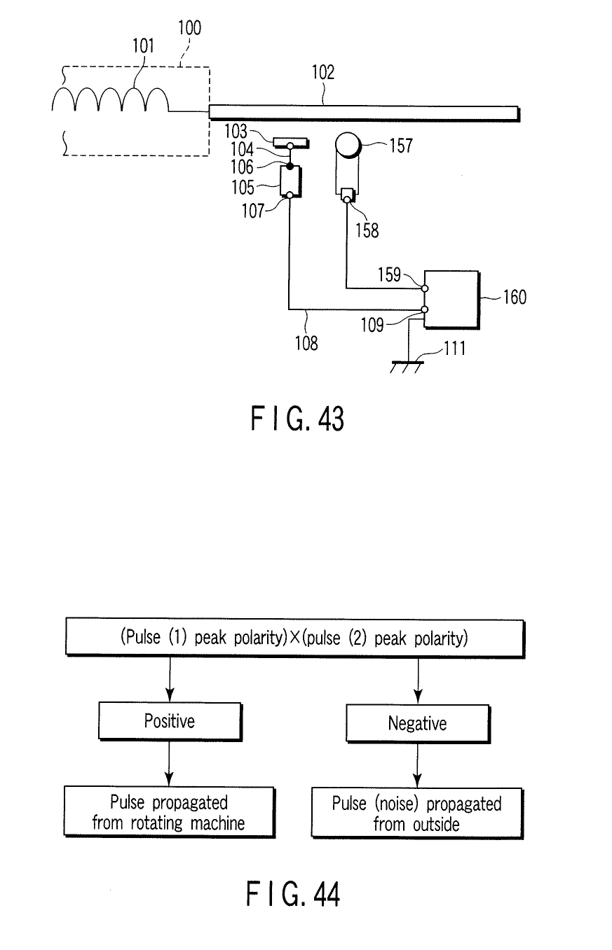

FIG. 43 is a view showing a partial discharge detection apparatus of an electrical rotating machine according to the 17th embodiment of the present invention

Referring to FIG. 43, an electrical conductive element 103 electrostatically coupled to a power line or neutral point lead line 102 connected to a stator winding 101 of the electrical rotating machine is arranged. As in FIG. 28, an input terminal 106 of an impedance converter 105 is electrically connected to the electrical conductive element 103 via a lead line 104. A signal processor 160 receives a partial discharge pulse signal from an output terminal 109 of a transmission line 108 connected to an output terminal 107 of the impedance converter 105 so as to match the impedances.

Additionally, a coil 157 magnetically coupled to the power line or neutral point lead line 102 is arranged. A current detector 158 such as a resistor to output a voltage is connected to the coil 157. The output terminal of the current detector 158 is connected to an input terminal 159 of the signal processor 160 through a transmission line.

As shown in FIG. 44, the signal processor 160 has a function of discriminating a signal propagated from the electrical rotating machine from a signal propagated from the opposite side on the basis of whether the product of the polarity of a pulse signal peak (1) obtained from the output terminal 107 of the impedance converter 105 connected to the electrical conductive element 103 and the polarity of a pulse signal peak (2) induced in the current detector 158 connected to the coil 157 is positive or negative.

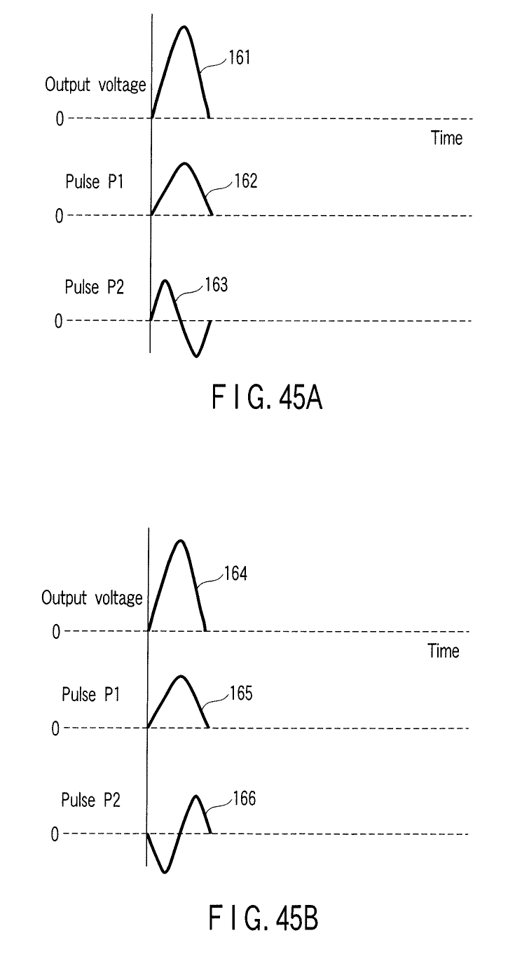

FIG. 45A shows a pulse voltage waveform 161 of a partial discharge signal flowing through the power line 102 shown in FIG. 43 from the stator winding of the electrical rotating machine to the outside, a pulse voltage waveform (P1) 162 at the output terminal 107 of the impedance converter 105, and a pulse voltage waveform (P2) 163 induced in the current detector 158 of the coil 157.

The waveform 163 induced in the coil 157 has a shape obtained by differentiating the waveform 161 of the power line 102. The polarity of the pulse peak equals the polarity of the first wave. The coil 157 is arranged in such a direction to make the pulse peak have a positive polarity when a positive pulse signal flows from the electrical rotating machine to the outside.

FIG. 45B shows a pulse voltage waveform 164 of a partial discharge signal flowing through the power line 102 shown in FIG. 43 from the outside to the stator winding of the electrical rotating machine, a pulse voltage waveform (P1) 165 at the output terminal 107 of the impedance converter 105, and a pulse voltage waveform (P2) 166 induced in the current detector 158 of the coil 157.

As shown in FIGS. 45A and 45B, the polarity of the voltage induced in the coil reverses depending on the flowing direction of the partial discharge signal.

When a negative pulse signal flows to the power line, the polarity of the signal induced in the coil is opposite to that when a positive pulse signal flows to the power line. That is, as shown in FIGS. 44, 45A, and 45B, when the product of the polarity of the pulse voltage waveform (P1) 162 or 165 at the output terminal 107 of the impedance converter 105 and the polarity of the pulse voltage waveform (P2) 163 or 166 induced in the current detector 158 of the coil 157 is positive, the partial discharge signal flowing to the power line can be estimated to flow from the electrical rotating machine to the outside. A signal flowing from the outside to the inside of the electrical rotating machine is determined as noise. Hence, detection can be done while removing external noise by the method shown in FIG. 44.

As described above, in the 12th embodiment of the present invention, at least one electrical conductive element electrostatically coupled to the power line or neutral point lead line 102 connected to the stator winding 101 and at least one coil magnetically coupled to the power line or neutral point lead line are arranged. A signal propagated from the electrical rotating machine is discriminated from a signal propagated from the outside of the electrical rotating machine on the basis of whether the product of the polarity of the output signal peak from the impedance converter connected to the electrical conductive element and the polarity of the output signal peak induced in the coil is positive or negative. It is unnecessary to alter the interior of the electrical rotating machine. It is possible to relatively easily attach a non-contact sensor to a high-voltage unit by only altering the metal frame around the power line or the neutral point lead line of the electrical rotating machine. In addition, it is possible to accurately detect partial discharge.

In the 12th embodiment, a capacitor may be provided in place of the electrical conductive element 103. A resistor may be provided in place of the impedance converter 105.

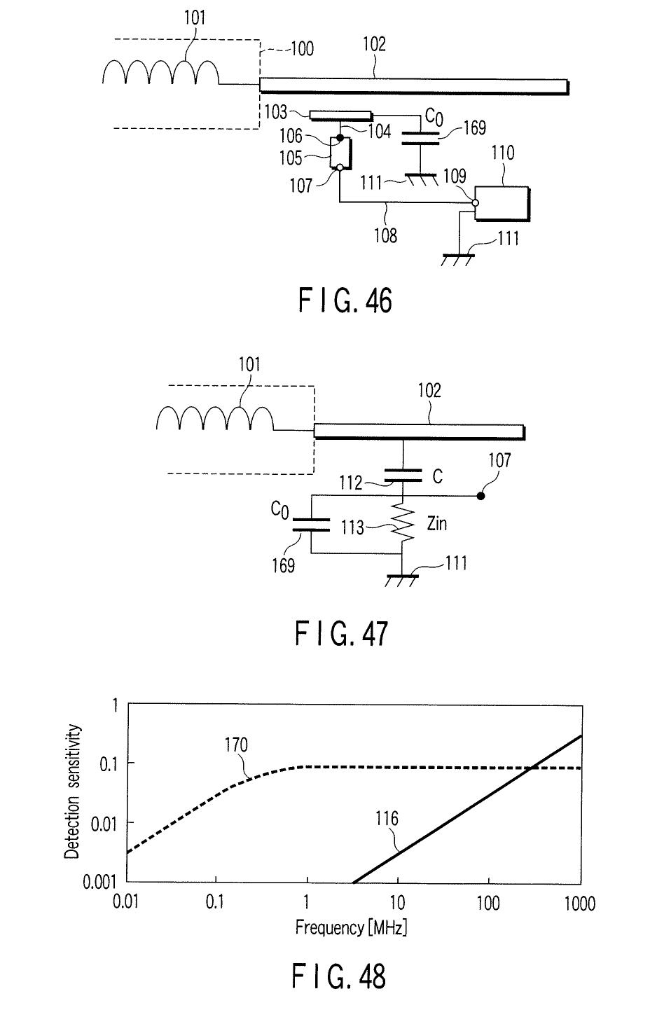

FIG. 46 is a view showing a partial discharge detection apparatus of an electrical rotating machine according to the 13th embodiment of the present invention.

Referring to FIG. 46, a stator winding 101 corresponding to one phase of the three phases (FIG. 46 shows one phase) of the electrical rotating machine is stored in a slot formed in a stator core (not shown) attached to the inner surface of a stator frame 100. A power line 102 is connected to the stator winding 101 of each phase. Alternatively, a neutral point lead line 102 may be connected to the neutral point of the three-phase stator windings. A support member (not shown) supports a non-contact electrical conductive element 103 which is made of copper or aluminum and electrostatically coupled to the power line or neutral point lead line 102.

An electrical element 169 having an electrostatic capacitance Co is connected to the element 103 and an input terminal 106 of an impedance converter 105 in which at least an input impedance Zin is higher than an output impedance Zout electrically is connected to the electrical conductive element 103 via a lead line 104. A partial discharge pulse signal is detected by inputting a detection signal from an output terminal 109 of a transmission line 108 (characteristic impedance Z₀) to a signal processor 110. The output terminal 109 is connected to an output terminal 107 of the impedance converter 105 so as to match the impedances.

As the transmission line 108 is generally used a coaxial cable having a characteristic impedance of 50 Ω or 75 Ω. Hence, Zout is often 50 Ω or 75 Ω.

The function of the partial discharge detection apparatus of the electrical rotating machine with the above arrangement will be described next.

FIG. 47 shows an electrical equivalent circuit viewed from the power line or neutral point lead line 102 in FIG. 46. The power line or neutral point lead line 102 is connected in series with an electrostatic capacitance C and a parallel circuit including the electrostatic capacitance Co between the electrical conductive element 103 and ground 111 and an input impedance Zi of the impedance converter 105 grounded to the ground point 111. The ratio of an output Vo from the output terminal 107 of the impedance converter 105 to an AC voltage peak value Vi at the power line or neutral point lead line 102 is given by
Vₒ/Vᵢ=1/\sqrt{{(1+Co/C)²+[1/(2πfCZᵢₙ)]²}} (4)

FIG. 48 shows a frequency characteristic 170 [20*Log(Vo/Vin)] in FIGS. 46 and 47 which is obtained by using the impedance converter having the input impedance Zin higher than Zout and setting C=1 pF, Co=10 pF, Zin=50 kΩ, and Zout=50 Ω, and a frequency characteristic 116 in FIGS. 30 and 31 which is obtained by setting C=1 pF and Z₀=50 Ω without using an impedance converter.

As is apparent from FIG. 48, in a partial discharge signal frequency band of several MHz or higher as shown in FIG. 38, the output gain is larger in the detection method shown in FIG. 46 that uses the impedance converter 105 and electrostatic capacitance Co connected to the electrical conductive element 103 than in the detection method shown in FIG. 30 that uses no impedance converter.

FIG. 33 shows an electrical equivalent circuit viewed from the signal processor 110 in FIG. 28. Resistance values (Z₀) 118 equal to the characteristic impedance Z₀ terminate the two terminals of the transmission line 108 to prevent a signal propagated in the transmission line 108 from reflecting at the terminals 107 and 109.

That is, when the output impedance Zout of the impedance converter 105, the characteristic impedance Z₀ of the transmission line 108, and the input impedance of the signal processor 110 shown in FIG. 28 equal (Zout=Z₀), the waveform can accurately be transmitted to the signal processor 110.

In the above embodiment, an electrical conductive element electrostatically coupled to the power line or neutral point lead line 102 connected to the stator winding of the electrical rotating machine is provided in a non-contact state. Even by providing a capacitor connected to the power line or neutral point lead line 102 in place of the electrical conductive element, partial discharge can be detected as described above.

In the partial discharge detection apparatus of the electrical rotating machine according to the 13th embodiment, the electrical conductive element 103 which is electrostatically coupled to the power line 102 connected to the stator winding corresponding to one phase of the three phases of the electrical rotating machine or the neutral point lead line 102 connected to the neutral point of the three-phase stator windings and which is in a non-contact state with respect to the power line or neutral point lead line 102 to have an electrostatic capacitance or one terminal of a capacitor connected to the power line or neutral point lead line 102 is connected to the input terminal of the impedance converter having the input impedance higher than the output impedance. A partial discharge pulse signal may be detected from the output terminal of the impedance converter or the output terminal of a transmission circuit connected to the output terminal of the impedance converter so as to match the impedances. It is unnecessary to alter the interior of the electrical rotating machine. It is possible to relatively easily attach a non-contact sensor to a high-voltage unit by only altering the metal frame around the power line or the neutral point lead line of the electrical rotating machine. In addition, partial discharge can be detected at a high detection sensitivity and accuracy.

The partial discharge detection apparatus and detection method according to the present invention can facilitate attachment in a non-contact state and accurately execute partial discharge detection and insulating diagnosis, greatly contributing to laying down an appropriate maintenance plan of a high-voltage electrical rotating machine and improving its reliability.

What is claimed is:

1. A partial discharge detection apparatus of an electrical rotating machine, comprising: an electrical conductive element which is electrostatically coupled to a stator winding corresponding to one phase of three phases of an electrical rotating machine or a power line or a neutral point lead line connected to a neutral point of three-phase stator windings and is in non-contact with the power line or neutral point lead line; an impedance converter which has an input terminal electrically connected to a terminal of the electrical conductive element and has an input impedance higher than an output impedance; and signal processing means for processing a detection signal obtained from an output terminal of the impedance converter to detect a partial discharge pulse signal.

2. A partial discharge detection apparatus of an electrical rotating machine, comprising: a capacitor having one terminal connected to a stator winding corresponding to a phase of three phases of the electrical rotating machine, a power line connected to the stator winding or a neutral point lead line; an impedance converter which has an input terminal connected to the other terminal of the capacitor and has an input impedance higher than an output impedance; and signal processing means for processing a detection signal obtained from an output terminal of the impedance converter to detect a partial discharge pulse signal.

3. A partial discharge detection apparatus of an electrical rotating machine according to claim 1 or 2, wherein a transmission circuit is connected to the output terminal of the impedance converter so as to match the impedances, and the signal processing means receives a detection signal obtained from an output terminal of the transmission circuit.

4. A partial discharge detection apparatus of an electrical rotating machine, comprising: at least two electrical conductive elements having equal or different capacitances, the electrical conductive elements being electrostatically coupled to a stator winding corresponding to one phase of three phases of an electrical rotating machine or a power line or neutral point lead line connected to a neutral point of three-phase stator windings and being in non-contact with the power line or neutral point lead line; at least two impedance converters having different input impedance values, each impedance converter having an input terminal electrically connected to the other terminal of a corresponding one of the electrical conductive elements and having an input impedance higher than an output impedance; and signal processing means for receiving detection signals obtained from the impedance converters and determining, as a partial discharge signal, a pulse signal that is obtained from one of the impedance converters, which has a large input impedance value, simultaneously with a peak detection timing of a pulse detection signal obtained from the impedance converter having a small input impedance value.

5. A partial discharge detection apparatus of an electrical rotating machine, comprising: at least two capacitors having equal or different capacitances and connected to a stator winding corresponding to one phase of three phases of an electrical rotating machine or a power line or neutral point lead line connected to a neutral point of three-phase stator windings; at least two impedance converters having different input impedance values, each impedance converter having an input terminal electrically connected to the other terminal of a corresponding one of the capacitors and having an input impedance higher than an output impedance; and signal processing means for receiving detection signals obtained from the impedance converters and determining, as a partial discharge signal, a pulse signal that is obtained from one of the impedance converters, which has a large input impedance value, simultaneously with a peak detection timing of a pulse detection signal obtained from the impedance converter having a small input impedance value.

6. A partial discharge detection apparatus of an electrical rotating machine according to claim 1 or 4, wherein the electrical conductive element and the impedance converter are supported by an insulating plate that is detachably attached to an inspection window provided in a hollow electrical conductive frame arranged around the power line or neutral point lead line.

7. A partial discharge detection apparatus of an electrical rotating machine according to claim 2 or 5, wherein the capacitor and the impedance converter are supported by an insulating plate that is detachably attached to an inspection window provided in a hollow electrical conductive frame arranged around the power line or neutral point lead line.

8. A partial discharge detection apparatus of an electrical rotating machine according to claim 1 or 4, further comprising a coil magnetically coupled to the power line or neutral point lead line in correspondence with the electrical conductive element, and the signal processing means detects the partial discharge signal by discriminating a signal propagated from the electrical rotating machine from a signal propagated from outside the electrical rotating machine on the basis of whether a product of a polarity of an output signal peak from the impedance converter and a polarity of an output signal peak induced in the coil is positive or negative.

9. A partial discharge detection apparatus of an electrical rotating machine according to claim 2 or 5, further comprising a coil magnetically coupled to the power line or neutral point lead line in correspondence with the capacitor, and the signal processing means detects the partial discharge signal by discriminating a signal propagated from the electrical rotating machine from a signal propagated from outside the electrical rotating machine on the basis of whether a product of a polarity of an output signal peak from the impedance converter and a polarity of an output signal peak induced in the coil is positive or negative.

10. A partial discharge detection method of an electrical rotating machine, comprising: electrically connecting an output terminal of an electrical conductive element that has an electrostatic coupling of not more than 10 pF with a stator winding corresponding to one phase of three phases of an electrical rotating machine or a power line or neutral point lead line connected to a neutral point of stator windings and is in non-contact with the power line or neutral point lead line to an input terminal of an impedance converter having an input impedance of not less than 500 Ω and an output impedance of 50 Ω to 75 Ω; and detecting a partial discharge signal by processing a detection signal obtained from an output terminal of a transmission circuit which has a characteristic impedance of 50 Ω to 75 Ω and is connected to the output terminal of the impedance converter so as to match the impedances.

11. A partial discharge detection method of an electrical rotating machine which comprises: two electrical conductive elements each of which has an electrostatic coupling of not more than 10 pF with a stator winding corresponding to one phase of three phases of the electrical rotating machine or a power line or neutral point lead line connected to a neutral point of stator windings and is in non-contact with the power line or neutral point lead line, a first impedance converter having an input impedance value of not less than 500 Ω and an output impedance value of 50 Ω to 75 Ω, and a second impedance converter having an input impedance value of not less than 50,000 Ω that is larger than that of the first impedance converter and an output impedance value of 50 Ω to 75 Ω;
characterized by electrically connecting one electrical conductive element to an input terminal of the first impedance converter and the other electrical conductive element to an input terminal of the second impedance converter; and determining, as a partial discharge signal, a pulse signal that is output from the second impedance converter simultaneously with a peak detection timing of a pulse signal output from the first impedance converter.

12. A partial discharge detection method of an electrical rotating machine, comprising: arranging at least one electrical conductive element or capacitor electrostatically coupled to a stator winding corresponding to one phase of three phases of an electrical rotating machine or a power line or neutral point lead line connected to a neutral point of stator windings and at least one coil magnetically coupled to the power line or neutral point lead line; and detecting a partial discharge signal by discriminating a signal propagated from the electrical rotating machine from a signal propagated from outside the electrical rotating machine on the basis of whether a product of a polarity of an output signal peak from one of the impedance converter and a resistor connected to the electrical conductive element or the capacitor and a polarity of an output signal peak induced in the coil is positive or negative.

13. A partial discharge detection apparatus of an electrical rotating machine, comprising: an electrical conductive element that is electrostatically coupled to a stator winding corresponding to one phase of three phases of an electrical rotating machine or a power line or neutral point lead line connected to a neutral point of three-phase stator windings and is in non-contact with the power line or neutral point lead line; a parallel circuit including an electrical element having an electrostatic capacitance electrically connected to the other terminal of the electrical conductive element and an impedance converter having an input impedance higher than an output impedance; and signal processing means for detecting a partial discharge pulse signal by processing a detection signal obtained from an output terminal of the impedance converter.

14. A partial discharge detection apparatus of an electrical rotating machine, comprising: a capacitor connected to a stator winding corresponding to one phase of three phases of an electrical rotating machine or a power line or neutral point lead line connected to a neutral point of three-phase stator windings; a parallel circuit including an electrical element having an electrostatic capacitance electrically connected to the other terminal of the capacitor and an impedance converter having an input impedance higher than an output impedance; and signal processing means for detecting a partial discharge pulse signal by processing a detection signal obtained from an output terminal of the impedance converter.

15. A partial discharge detection method of an electrical rotating machine, comprising: arranging, in a metal frame connected to a stator frame of an electrical rotating machine, one of a power line corresponding to a stator coil of three phases and a neutral point lead line connected to a neutral point of three-phase stator coils, the power line or neutral point lead line propagating a partial discharge signal generated by degradation of the stator coil in the stator frame; installing two sensors each including a loop antenna around the power line or neutral point lead line while spacing the sensors apart by a predetermined distance and arranging the sensors or wiring signal lead lines from the sensors so as to cause peak values of output pulse waveforms from the signal lead lines connected to the sensors to have opposite polarities; adjusting lengths of the signal lead lines of the sensors so as to cause a pulse signal which is induced by an electrical pulse signal propagated to the power line or neutral point lead line in a direction to enter the electrical rotating machine and output to a signal lead line terminal connected to the sensor far from the stator coil and a pulse signal which is induced by the pulse signal flowing to the power line or neutral point lead line and output to a signal lead line terminal connected to the sensor on a side of the stator coil to arrive at the same timing; and detecting the partial discharge signal generated by degradation of the stator coil from a sum of pulse waveforms obtained through the two signal lead lines.
